(19) United States
(12) Patent Application Publication
(10) Pub. No.: US 2016/0139924 A1
(43) Pub. Date: May 19, 2016

(54) Machine Level Instructions to Compute a 4D Z-Curve Index from 4D Coordinates

(71) Applicant: Intel Corporation, Santa Clara, CA (US)

(72) Inventors: Arnold Kerry EVANS, Chandler, AZ (US); Elmoustapha OULD-AHMED-VALL, Phoenix, AZ (US)

(21) Appl. No.: 14/542,502

(22) Filed: Nov. 14, 2014

(51) Int. Cl. G06F 9/30; G06F 9/38

(52) U.S. Cl. CPC G06F 9/30145; G06F 9/3802; G06F 9/30134

(57) ABSTRACT

In one embodiment, a processor includes 32-bit and 64-bit machine level instructions to compute a 4D Z-curve Index. A processor decode unit is configured to decode a z-curve ordering instruction having three source operands, each operand associated with one of a first, second, or third coordinate and a processor execution unit is configured to execute the decoded instruction before outputting the 4D Z-curve index to a location specified by a destination operand.

### BACKGROUND

1. Field

Embodiments relate generally to the field of computer processors. More particularly, to an apparatus including machine level instructions to compute a 4D Z-curve index from 4D coordinates.

2. Description of the Related Art

A Z-order curve is a type of space-filling curve, which is a continuous function whose domain is the unit interval [0,1]. Z-ordering (e.g., Morton ordering) can provide significant performance improvements for large data sets where multidimensional locality is important, including sparse and dense matrix operations (especially matrix multiply), finite element analysis, image analysis, seismic analysis, ray tracing, and others. However, the computation of Z-order curve indices from coordinates may be computationally intensive.

### BRIEF DESCRIPTION OF THE DRAWINGS

A better understanding of the present embodiments can be obtained from the following detailed description in conjunction with the following drawings, in which:

FIG. 1A-B illustrate an exemplary Z-order mapping for an 8×8 matrix;

FIG. 2A-B illustrate an exemplary multi-stage logic for a hardware Z-curve index implementation, according to an embodiment;

FIG. 3 shows a bock diagram of a multi-stage logic arrangement to implement a 32-bit 4D Z-curve index instruction, according to an embodiment;

FIG. 4 shows a bock diagram of a multi-stage logic arrangement to implement a 64-bit 4D Z-curve index instruction, according to an embodiment;

FIG. 5 is a block diagram of operands and logic for an instruction to compute a 4D Z-curve index from four coordinates, according to an embodiment;

FIG. 6 is a block diagram of additional logic to execute an instruction to compute a 4D Z-curve index from four coordinates, according to an embodiment;

FIG. 7 is a flow diagram for processing a 4D Z-curve index instruction, according to an embodiment;

FIG. 8A-B are block diagrams illustrating a generic vector friendly instruction format and instruction templates thereof according to an embodiment;

FIG. 9A-D are block diagrams illustrating an exemplary specific vector friendly instruction format according to an embodiment.

FIG. 10 is a block diagram of a register architecture according to one embodiment;

FIG. 11A is a block diagram illustrating both an exemplary in-order fetch, decode, retire pipeline and an exemplary register renaming, out-of-order issue/execution pipeline;

FIG. 11B is a block diagram illustrating both an exemplary embodiment of an in-order fetch, decode, retire core and an exemplary register renaming, out-of-order issue/execution architecture core to be included in an embodiment;

FIG. 12A-B illustrate a block diagram of an exemplary in-order core architecture;

FIG. 13 is a block diagram of a processor having more than one core, an integrated memory controller, and integrated graphics, according to an embodiment;

FIG. 14 illustrates a block diagram of an exemplary computing system;

FIG. 15 illustrates a block diagram of a second exemplary computing system;

FIG. 16 illustrates a block diagram of a third exemplary computing system;

FIG. 17 illustrates a block diagram of a system on a chip (SoC), according to an embodiment; and

FIG. 18 illustrates a block diagram contrasting the use of a software instruction converter to convert binary instructions in a source instruction set to binary instructions in a target instruction set.

### DETAILED DESCRIPTION

In the following description, for the purposes of explanation, numerous specific details are set forth in order to provide a thorough understanding of the embodiments described below. It will be apparent, however, to one skilled in the art that the embodiments can be practiced without some of these specific details. In other instances, well-known structures and devices are shown in block diagram form to avoid obscuring the underlying principles of the embodiments. In one embodiment, architectural extensions are described which extend the Intel Architecture (IA), but the underlying principles are not limited to any particular ISA.

### Vector and SIMD Instruction Overview

Certain types of applications often require the same operation to be performed on a large number of data items (referred to as “data parallelism”). Single Instruction Multiple Data (SIMD) refers to a type of instruction that causes a processor to perform an operation on multiple data items. SIMD technology is especially suited to processors that can logically divide the bits in a register into a number of fixed-sized data elements, each of which represents a separate value. For example, the bits in a 256-bit register may be specified as a source operand to be operated on as four separate 64-bit packed data elements (quad-word (Q) size data elements), eight separate 32-bit packed data elements (double word (D) size data elements), sixteen separate 16-bit packed data elements (word (W) size data elements), or thirty-two separate 8-bit data elements (byte (B) size data elements). This type of data is referred to as “packed” data type or a “vector” data type, and operands of this data type are referred to as packed data operands or vector operands. In other words, a packed data item or vector refers to a sequence of packed data elements, and a packed data operand or a vector operand is a source or destination operand of a SIMD instruction (also known as a packed data instruction or a vector instruction).

The SIMD technology, such as that employed by the Intel® Core™ processors having an instruction set including x86, MMX™, Streaming SIMD Extensions (SSE), SSE2, SSE3, SSE4.1, and SSE4.2 instructions, has enabled a significant improvement in application performance. An additional set of SIMD extensions, referred to the Advanced Vector Extensions (AVX) (AVX1 and AVX2) and using the Vector Extensions (VEX) coding scheme, has been released (see, e.g., see Intel® 64 and IA-32 Architectures Software Developers Manual, September 2014; and see Intel® Intel® Architecture Instruction Set Extensions Programming Reference, September 2014).

### Z-Curve Indexing Overview

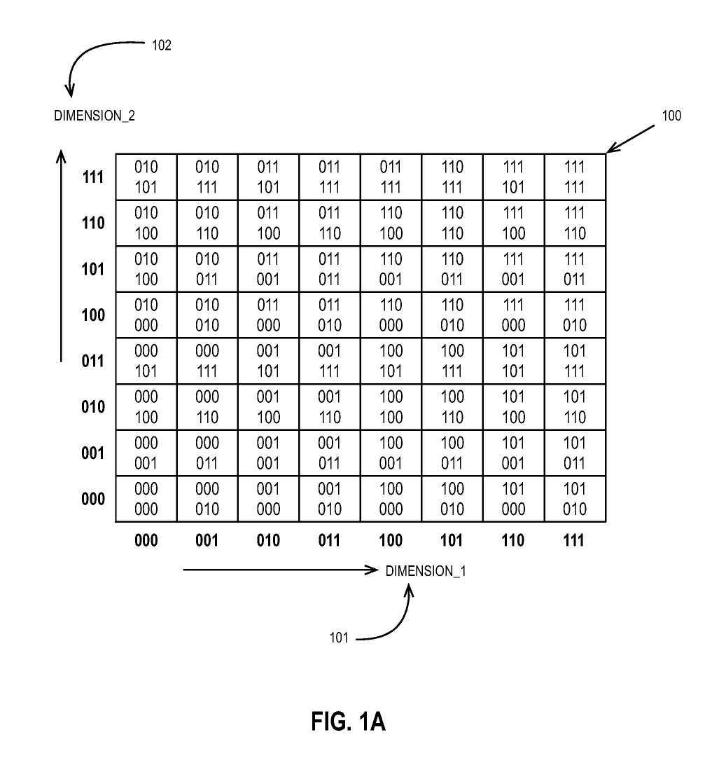

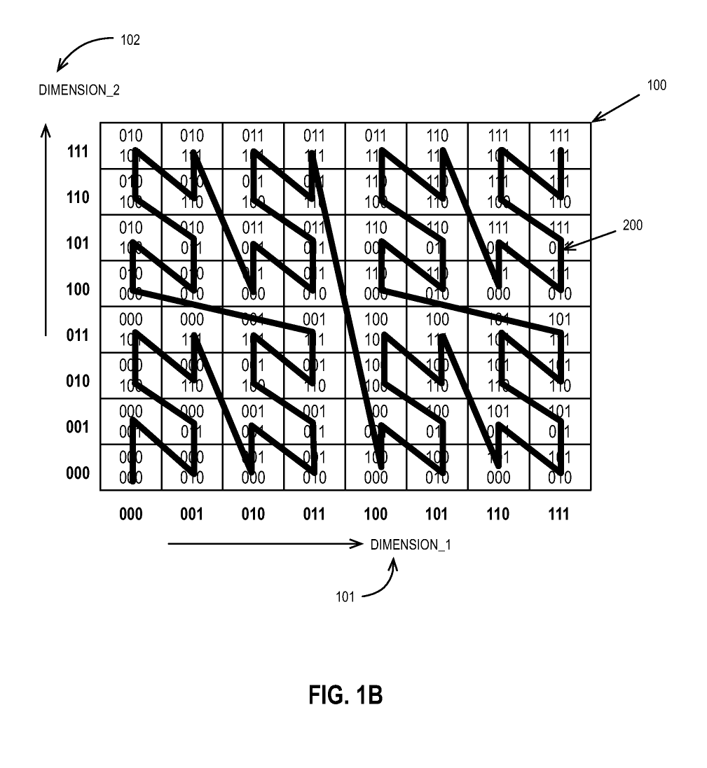

FIG. 1A illustrates a Z-order key mapping for each element of the illustrated 8×8 matrix 100. Within each element displayed, the higher order bits are on top and the lower order bits on the bottom. One implementation of Z-curve ordering is performed by interleaving (e.g., shuffling) the bits of each of the original indices in each dimension. The Z-ordering shown in each element of the illustrated matrix 100 is generated by a bitwise interleave of the values of dimension_1 101 and dimension_2 102 of each element in the matrix 100.

For example, a Z-curve index of the element at coordinate [2,3] (e.g., binary 010 in dimension_1 101 and binary 011 in dimension_2 102) can be determined by interleaving the bits of the coordinates of each dimension, resulting in a binary Z-curve index of 001101 (e.g., 0x0D). The exemplary Z-curve index value indicates that matrix element at coordinate [2,3] is the 13^{th} (zero-indexed, based 10) index in a Z-order curve of the exemplary matrix 100.

FIG. 1B is a graphical illustration of a Z-curve 200 created by sequentially tracing matrix elements of the element in Z-order. A simple 2D Z-curve and associated indices are shown in FIG. 1B for exemplary purposes. For a limited number of coordinates having a limited bit-length, a look-up table filled with pre-computed values can be used to quickly determine the Z-curve index for a set of coordinates. This may become impractical as the number and size of the coordinates increase. In one embodiment, a processor includes 32-bit and 64-bit machine level instructions to compute a 4D Z-curve Index to reduce computational overhead and improve application performance when analyzing large data sets.

### Machine Level Instructions to Compute a 4D Z-Curve Index

In one embodiment the machine instructions cause a processor to computer the 4D Z-curve index by performing bit-manipulation operations on the input coordinate values.

Table 1 below shows the bit operations of an exemplary 32-bit 4D Z-curve index.

TABLE 1
32-Bit Z-Curve Bit Shuffle

src1[0:7] = x[0:7]
src1[8:15] = y[0:7]
src2[0:7] = z[0:7]
src2[8:15] = t[0:7]
zorder4d_i dst, src1, src2
dst[0:28:4] = src1[0:7]
dst[1:29:4] = src1[8:15]
dst[2:30:4] = src2[0:7]
dst[3:31:4] = src2[8:15

As shown in Table 1, the 32-bit z-curve index instruction shuffles eight low order bits of each source coordinate into a 32-bit destination. In one embodiment an x coordinate value and a y coordinate value are packed into register indicated by a first source operand. A z coordinate and t coordinate are packed into a register indicated by a second source operand. The bits of each coordinate value are stagger distributed to the destination with a four-bit stride per-source and a one-bit offset between sources, such that bits are distributed to the zero bit, then every fourth bit within the specified range. For example, bits of the x coordinate are distributed to bits 0, 4, 8 . . . 28; y coordinate bits are distributed to bits 1, 5, 8 . . . 29; z coordinate bits are distributed to bits 2, 6, 10, . . . 30; and t coordinate bits are distributed to bits 3, 7, 11, . . . 31.

Table 2 below shows the bit operations of a 64-bit 4D Z-curve index instruction.

TABLE 2
64-Bit Z-Curve Bit Shuffle

src1[0:15] = x[0:15]
src1[16:31] = y[0:15]
src2[0:15] = z[0:15]
src2[16:31] = t[0:15]
zorder4d_i dst, src1, src2
dst[0:60:4]=src1[0:15]
dst[1:61:4]=src1[16:31]
dst[2:62:4]=src2[0:15]
dst[3:63:4]=src2[16:31]

As shown in Table 2, the 64-bit z-curve index instruction shuffles 16 low order bits of each source coordinate into a 64-bit destination. In one embodiment, two coordinate values are packed into a register, as with the 32-bit instruction. The 16 low order bits of each coordinate value are stagger distributed to the destination with a four bit stride per-source and a one-bit offset between sources, such that bits the bits are distributed to the zero bit, then every third bit within the specified range. For example, bits of the x coordinate are distributed to bits 0, 4, 8 . . . 60; y coordinate bits are distributed to bits 1, 5, 8 . . . 61; z coordinate bits are distributed to bits 2, 6, 10, . . . 62; and t coordinate bits are distributed to bits 3, 7, 11, . . . 63. Exemplary high-level pseudo-code for calculating a 32-bit Z-curve index is shown in Table 3 below. Exemplary high-level pseudo-code for calculating a 64-bit Z-curve index is shown in Table 4 below. The pseudo-code demonstrates exemplary high-level logic that may be used to perform the bit-distribution of shown in Table 1 and Table 2 above.

TABLE 3
32-bit Z-curve Index Pseudo-Code

```
UINT u32_zorder4d_i(UINT x, UINT y, UINT z, UINT i)
{
      x =  x & 0x000000ff
      x = (x \hat{ } (x << 16))& 0x00c0003f
      x = (x \hat{ } (x << 8)) & 0x00c03807
      x = (x \hat{ } (x << 4)) & 0x08530853
      x = (x \hat{ } (x << 2)) & 0x09090909
      x = (x \hat{ } (x << 1)) & 0x11111111
      y =  y & 0x000000ff
      y = (y \hat{ } (y << 16)) & 0x00c0003f
      y = (y \hat{ } (y << 8))  & 0x00c03807
      y = (y \hat{ } (y << 4))  & 0x08530853
      y = (y \hat{ } (y << 2))  & 0x09090909
      y = (y \hat{ } (y << 1))  & 0x11111111
      z =  z & 0x000000ff
      z = (z \hat{ } (z << 16)) & 0x00c0003f
      z = (z \hat{ } (z << 8))  & 0x00c03807
      z = (z \hat{ } (z << 4))  & 0x08530853
      z = (z \hat{ } (z << 2))  & 0x09090909
      z = (z \hat{ } (z << 1))  & 0x11111111
      t = t & 0x000000ff
      t = (t \hat{ } (t << 16)) & 0x00c0003f
      t = (t \hat{ } (t << 8))  & 0x00c03807
      t = (t \hat{ } (t << 4))  & 0x08530853
      t = (t \hat{ } (t << 2))  & 0x09090909
      ·t = (t \hat{ } (t << 1))  & 0x11111111
      return (x | (y << 1) | (z << 2) | (t << 3 ))
}
```

TABLE 4
64-bit Z-curve Index Pseudo-Code

```
ULONG u64_zorder4d_i(UINT x, UINT y, UINT z, UINT i)
{
    ULONG rx = x & 0x0000ffff
    ·rx = (rx \hat{ } (rx << 32))& 0x0000f800000007ff
    rx = (rx \hat{ } (rx << 16))& 0x0000f80007c0003f
    rx = (rx \hat{ } (rx << 8)) & 0x00c0380700c03807
    rx = (rx \hat{ } (rx << 4)) & 0x0843084308430843
    rx = (rx \hat{ } (rx << 2)) & 0x0909090909090909
    rx = (rx \hat{ } (rx << 1)) & 0x1111111111111111
    ULONG ry=y & 0x0000ffff
    ·ry = (ry \hat{ } (ry << 32))& 0x0000f800000007ff
    ry = (ry \hat{ } (ry << 16))& 0x0000f80007c0003f
    ry = (ry \hat{ } (ry << 8)) & 0x00c0380700c03807
    ry = (ry \hat{ } (ry << 4)) & 0x0843084308430843
    ry = (ry \hat{ } (ry << 2)) & 0x0909090909090909
    ry = (ry \hat{ } (ry << 1)) & 0x1111111111111111
    ULONG rz=z & 0x0000ffff
    ·rz = (rz \hat{ } (rz << 32))& 0x0000f800000007ff
    rz = (rz \hat{ } (rz << 16))& 0x0000f80007c0003f
    rz = (rz \hat{ } (rz << 8)) & 0x00c0380700c03807
    rz = (rz \hat{ } (rz << 4)) & 0x0843084308430843
    rz = (rz \hat{ } (rz << 2)) & 0x0909090909090909
    rz = (rz \hat{ } (rz << 1)) & 0x1111111111111111
    ULONG rt=t & 0x0000ffff
    ·rt = (rt \hat{ } (rt << 32))& 0x0000f800000007ff
    ·rt = (rt \hat{ } (rt << 16))& 0x0000f80007c0003f
    ·rt = (rt \hat{ } (rt << 8)) & 0x00c0380700c03807
    rt = (rt \hat{ } (rt << 4)) & 0x0843084308430843
    rt = (rt \hat{ } (rt << 2)) & 0x0909090909090909
    rt = (rt \hat{ } (rt << 1)) & 0x1111111111111111
    return (x | (y << 1) | (z << 2) | (t <<3 ))
}
```

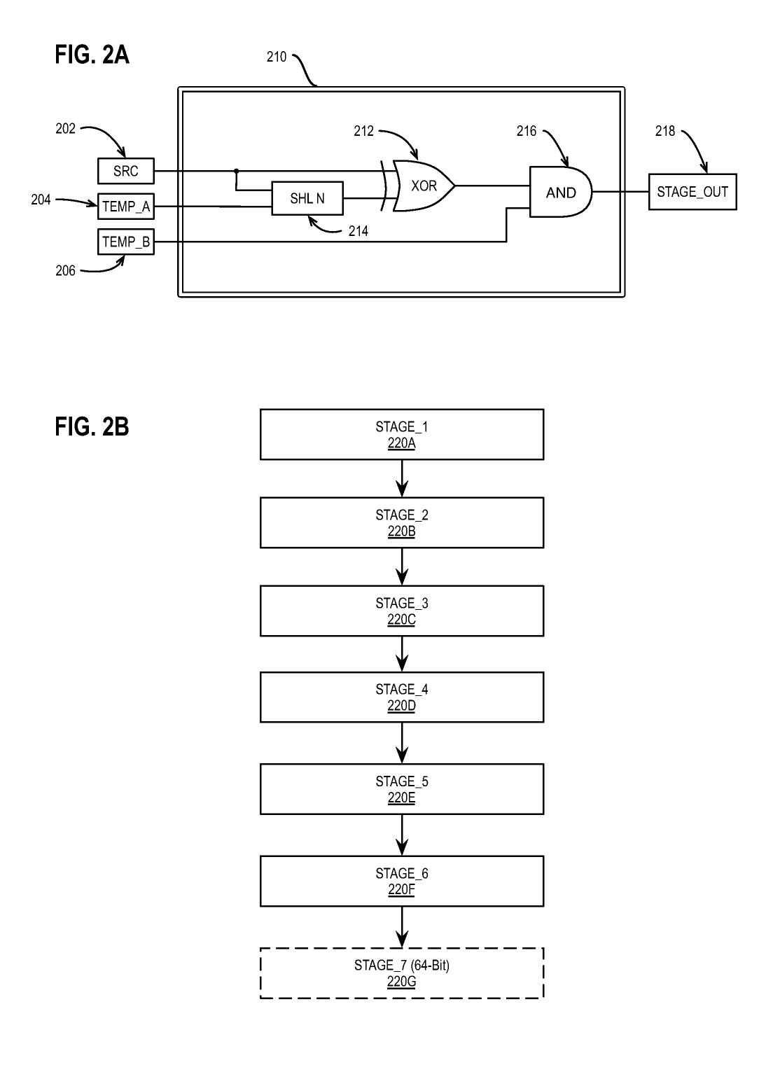

FIGS. 2A-B illustrate exemplary multi-stage logic for a hardware Z-curve index implementation, according to an embodiment. FIG. 2A shows a single stage 210 of logic including an XOR gate 212, a shifter circuit 214, and an AND gate 216. A source input 202 can be a source coordinate value or input from a previous logic stage. In one embodiment, multiple dimensions are packed into a single operand, as shown in Table 1 and Table 2. Additional logic is included in the processing logic to split the dimension values from the source operands. In one embodiment, multiple instances of the single stage 210 of logic are included to process the multiple dimensions from each source operand in parallel.

In one embodiment, a set of temporary registers (e.g., temp_A 204, temp_2 306) are used to supply control values, where temp_A 204 supplies a shift value to the shifter circuit and temp_B 206 supplies a bitmask which will be applied before data is output via stage_out 218. The stage_out 218 value supplies the SRC 202 for each successive logic stage excepting the final stage. For the final stage, the stage_out 218 is an portion of the destination output corresponding to the initial coordinate provided as a source (e.g., SRC 202)

FIG. 2B shows a bock diagram of a multi-stage logic arrangement to implement a 4D Z-curve index instruction, according to an embodiment. In such embodiment, a processor includes an execution unit that is configured to perform logic operations on each source input and combine the per-coordinate components into a single output. In one embodiment, multiple instances 220 (e.g., 220A-F for 32-bits, 220A-G for 64-bits) of the single stage 210 of logic are arranged to compute a portion of a 4D Z-curve index for a single input coordinate. The stage_out 218 of all but the final stage provides the source of a subsequent stage. The stage_out 218 of the final stage provides the portion of the Z-curve index associated with the single initial input coordinate. In one embodiment the output of the respective coordinates are then combined before output to a destination register.

The operations to compute the respective components of each Z-curve index can be performed in series or in parallel in the execution unit. For example, the single macro-instruction to compute the Z-curve index can be decoded into multiple micro-operations which each cause one or more execution units to perform operations for each source coordinate before combining the separate intermediate values.

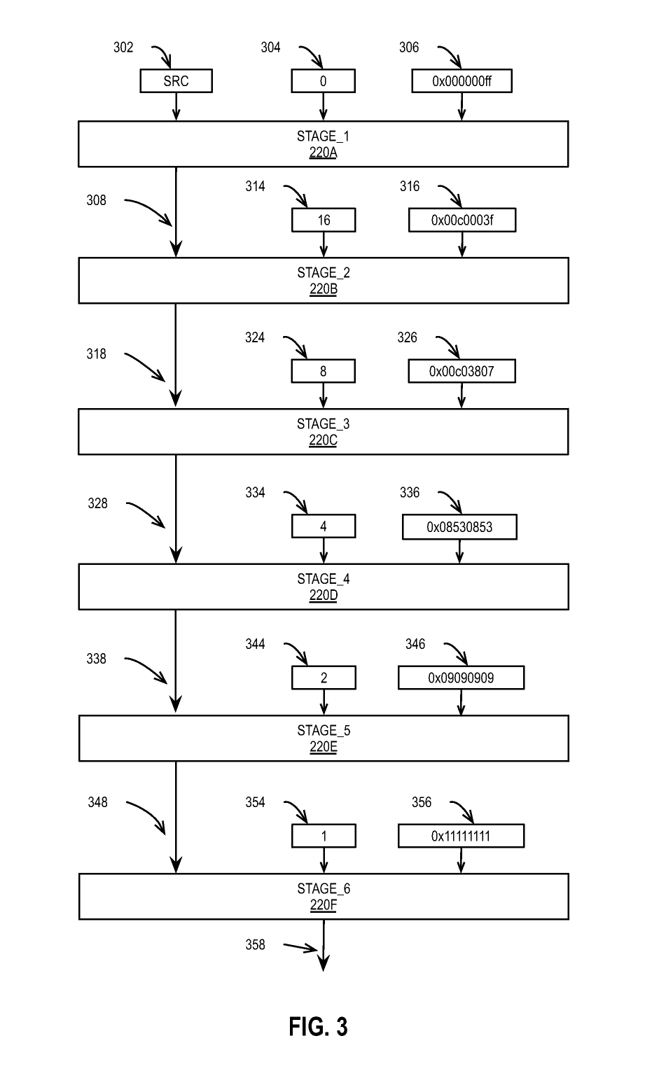

FIG. 3 shows a bock diagram of a multi-stage logic arrangement to implement a 32-bit 4D Z-curve index instruction, according to an embodiment. In one embodiment, multiple instances of logic 210 shown in FIG. 2A can be coupled as shown by logic stages 220A-F as shown in FIG. 2B. The multiple stage logic can be used to perform the Z-curve index bit shuffle for each coordinate. The first logic stage 220A accepts a 32-bit source input 302, with a zero left shift 304 and a mask value 306 of 0x000000ff. The first logic stage 220A output 308 is provided as a source for the second logic stage 220B, which accepts as input a 16-bit left shift 314 and a mask value 316 of 0x00c0003f. The second logic stage 220B output 318 is provided as a source for the third logic stage 220C, which accepts as input an eight-bit left shift 324 and a mask value 326 of 0x00c03807. Output 328 from the third logic stage 220C is provided as a source for the fourth logic stage 220D, which accepts as input a four-bit left shift 334 and a mask value 336 of 0x08530853. Output 338 from the fourth logic stage 220D is provided as a source for the fifth logic stage 220E, which accepts as input a two-bit left shift 344 and a mask value 346 of 0x09090909. The output 348 of the fifth logic stage 220E is provided as a source for the sixth logic stage 220F, which accepts as input a one-bit left shift 354 and a mask value 356 of 0x11111111. The output 358 of the sixth logic stage 220F is shifted and combined with the output of the other source coordinates and output as the 4D Z-curve index result. Each source input undergoes a similar logic pipeline. In one embodiment, the micro-operations for each input are performed in parallel.

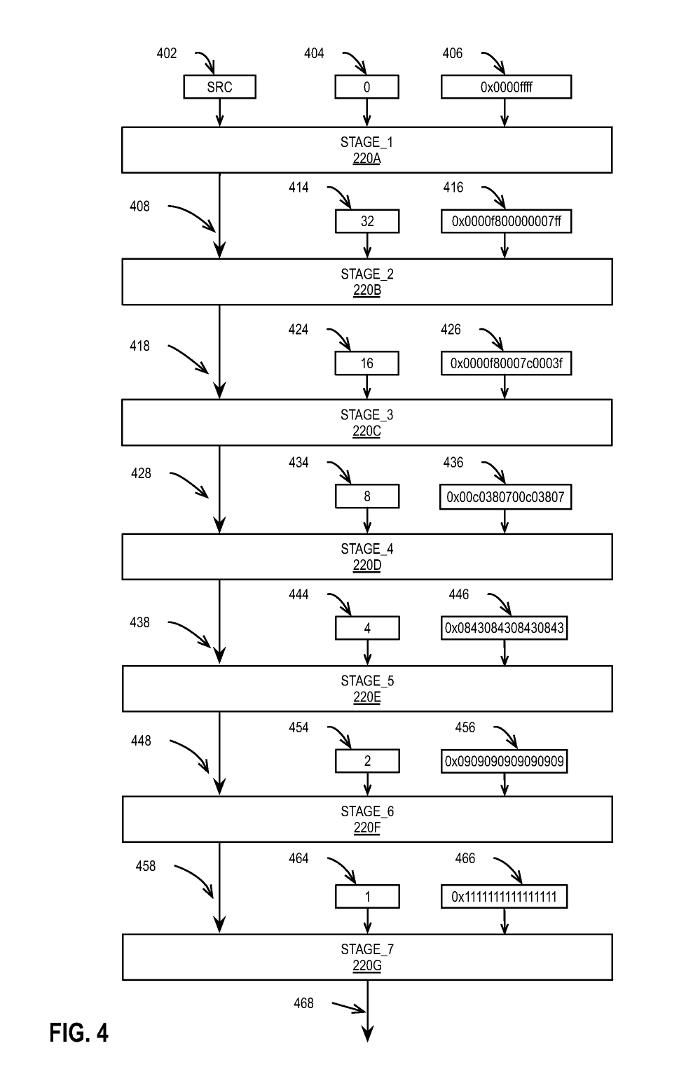

FIG. 4 shows a bock diagram of a multi-stage logic arrangement to implement a 64-bit 4D Z-curve index instruction, according to an embodiment. Each logic stage 220A-F shown in FIG. 2B can be used to perform the Z-curve index bit shuffle for each coordinate. In one embodiment, the logic stages are configured to perform operations with at least 64-bits of accuracy to produce 64-bit output. The first logic stage 220A accepts a 64-bit source input 402, with a zero left shift 404 and a mask value 406 of 0x0000ffff. The first logic stage 220A output 408 is provided as a source for the second logic stage 220B, which accepts as input a 32-bit left shift 414 and a mask value 416 of 0x0000f800000007ff. The second logic stage 220B output 418 is provided as a source for the third logic stage 220C, which accepts as input a 16-bit left shift 424 and a mask value 426 of 0x0000f80007c0003f. The third logic stage 220C output 428 is provided as a source for the fourth logic stage 220D, which accepts as input a 8-bit left shift 434 and a mask value 436 of 0x00c0380700c03807. The fourth logic stage 220D output 438 is provided as a source for the fifth logic stage 220E, which accepts as input a 4-bit left shift 444 and a mask value 446 of 0x0843084308430843. The fifth logic stage 220E output 448 is provided as a source for the fifth logic stage 220E, which accepts as input a 2-bit left shift 454 and a mask value 456 of 0x0909090909090909. The fifth logic stage 220E output 458 is provided as a source for the sixth logic stage 220F, which accepts as input a one-bit left shift 464 and a mask value 466 of 0x1111111111111111. The output 468 of the seventh logic stage 220G is shifted and combined with the output of other source coordinates and returned as the 4D Z-curve index result. Each source input undergoes a similar logic pipeline. In one embodiment the micro-operations for each input are performed in parallel.

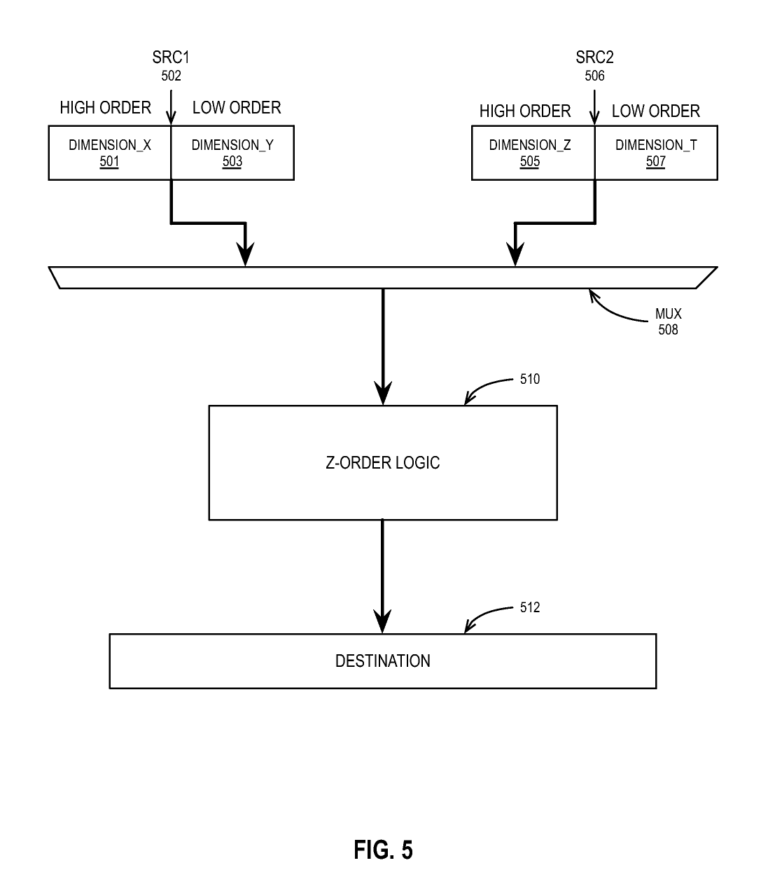

FIG. 5 is a block diagram of operands and logic for an instruction to compute a 4D Z-curve index from four coordinates, according to an embodiment. An embodiment of the instruction includes two source operands. Each source operand indicates a single register, memory address, or immediate value storing a first coordinate in high order bits and a second coordinate in low order bits. For example, FIG. 5 shows a first source operand (e.g., SRC 1 502) that indicates or includes a dimension X coordinate value 501 and a dimension Y coordinate value 503. A second source operand (e.g., SRC 1 506) includes an indication to a dimension Z coordinate value 505 and a dimension T coordinate value 507. At the micro-operation level the coordinates associated with the operands are stored in processor registers before being processed by an execution unit. In one embodiment, the coordinates are unpacked from the operand into separate registers before being processed by the Z-order logic. In one embodiment, a multiplexer (e.g., mux 508) couples the source register to z-order logic 510 in the processor execution unit, which computes the Z-order index from the source coordinates. An exemplary representation of an input, 32-bit pre-output and final output is shown in Table 5 below.

TABLE 5
Z-order logic output

| Input | High Order | | | | | | | | Low Order | | | | | | | |
|---|---|---|---|---|---|---|---|---|---|---|---|---|---|---|---|---|
| SRC1 | x | x | x | x | x | x | x | x | y | y | y | y | y | y | y | y |
| SRC2 | z | z | z | z | z | z | z | z | t | t | t | t | t | t | t | t |

REG

| | | | | | | | | | | | | | | | | | | | | | | |
|---|---|---|---|---|---|---|---|---|---|---|---|---|---|---|---|---|---|---|---|---|---|---|
| SRC1A | . . . | x | 0 | 0 | 0 | x | 0 | 0 | 0 | x | 0 | 0 | 0 | x | 0 | 0 | 0 | x | 0 | 0 | 0 | x |
| SRC1B | . . . | y | 0 | 0 | 0 | y | 0 | 0 | 0 | y | 0 | 0 | 0 | y | 0 | 0 | 0 | y | 0 | 0 | 0 | y |
| SRC2A | . . . | z | 0 | 0 | 0 | z | 0 | 0 | 0 | z | 0 | 0 | 0 | z | 0 | 0 | 0 | z | 0 | 0 | 0 | z |
| SRC2B | . . . | t | 0 | 0 | 0 | t | 0 | 0 | 0 | t | 0 | 0 | 0 | t | 0 | 0 | 0 | t | 0 | 0 | 0 | t |
| DEST | . . . | x | t | z | t | x | t | z | y | x | t | z | y | x | t | z | y | x | t | z | y | x |

Table 5 above shows the pre-output for each source input. Each x, y, z, or t value in Table 5 indicates a single bit of the indicated coordinate value, with the least significant bits to the right and the most significant bits on the left. While the y and t coordinates are shown in the low order bits of SRC1 502 and SRC2 506, this arrangement is exemplary and other arrangements are possible. In one embodiment, the packed dimensions in the source SRC1 502 and SRC2 506 operands are unpacked into temporary registers and processed by the Z-order logic 510.

As shown in Table 5, the Z-order logic 510 outputs values to temporary registers SRC1A and SRC1B based on the SRC1 502 operand. The Z-order logic 510 outputs values to temporary registers SRC2A and SRC2B based on the SRC2 506 operand. The bits of each coordinate value are distributed to the temporary register with a four-bit stride. The Z-order index is created by left shifting the values in the temporary registers and then combining the values by performing a bitwise OR operation on the shifted values. As indicated by the pseudo-code shown in Table 3, the bits of the y coordinate in register SRC1B are left shifted by one bit. The bits of the z coordinate in register SRC2A are left shifted by two bits. The bits of the t coordinate in register SRC2B are left shifted by three bits. The shifted pre-output values in the temporary registers are combined and output to a DEST location specified by a destination operand 512 of the instruction. In one embodiment, the registers shown are SIMD/vector registers and the instructions are SIMD instructions to perform vector operations.

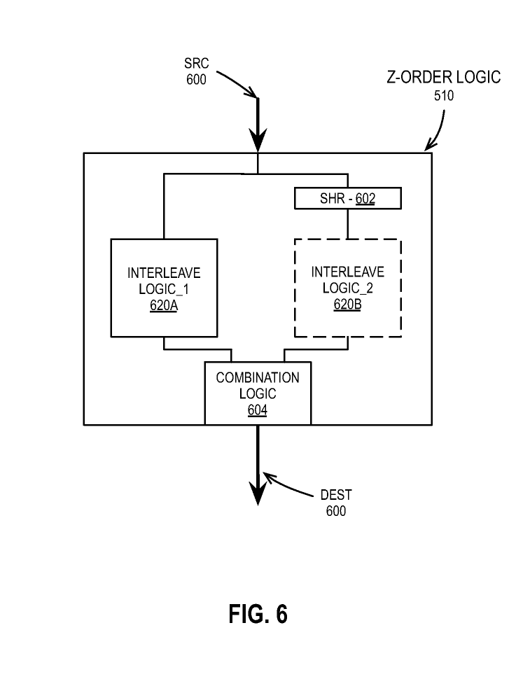

FIG. 6 is a block diagram of additional logic to execute an instruction to compute a 4D Z-curve index from four coordinates, according to an embodiment. In one embedment the two coordinate values in each source operand (e.g., SRC 600) are processed in parallel by the Z-order logic 510. In one embodiment a first interleave logic block (e.g., interleave_logic_1 620A) includes a logic to compute a 32-bit or 64-bit Z-order index, such as multi-stage logic 220 (e.g., 220A-F for 32-bit, 220A-G for 64-bit) of FIG. 2B. During processing a bit mask zeros out the higher-order bits containing one of the two coordinate values. A second interleave logic block (e.g., interleave_logic_2 620B) can be included to parallel process the coordinate values contained in the higher order bits, which are shifted or rotated into the low order bits by a shifter circuit 602 configured to perform a right shift, a rotate right, or rotate left operation. In one embodiment, combination logic 604 shifts and combines the pre-output values into an intermediate temporary register before being output to a destination (e.g., DEST 600) indicated by the destination operand of the instruction. The processing operation then repeats for the second source operand.

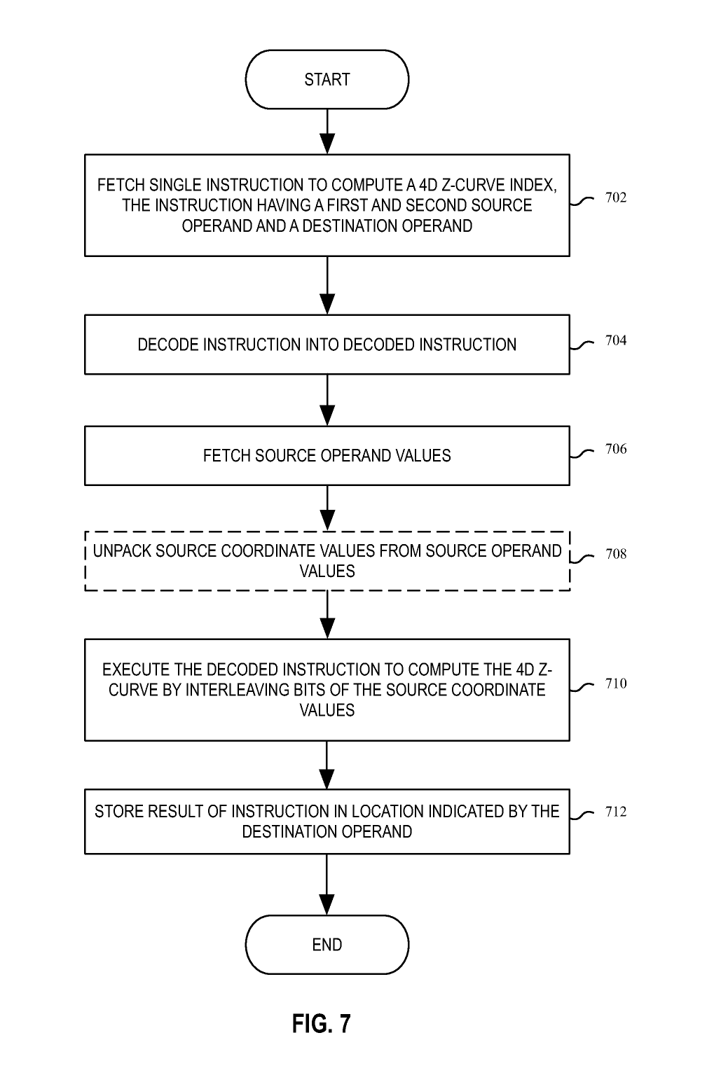

FIG. 7 is a flow diagram for processing a 4D Z-curve index instruction, according to an embodiment. As shown at block 702, the instruction pipeline beings when the processor fetches a single z-curve index instruction to compute a 4D Z-curve index. The instruction has a first and second source operand as well as a destination operand, as shown at block 702.

As shown at block 704, the processor decodes the Z-curve index instruction into a decoded instruction. In one embodiment, the decoded instruction is a single operation. In one embodiment the decoded instruction is includes one or more logical micro-operations to perform each sub-element of the instruction. The micro-operations can be hard-wired or microcode operations to can cause components of the processor, such as an execution unit, to perform various operations to implement the instruction.

In one embodiment the decoded instruction causes components of the processor, such as an execution unit, to perform various operations including an operation to fetch the source operand values indicated by the source operands, as shown at block 706. In various embodiments the source operands can include register identifiers, memory addresses or immediate values.

In one embodiment, as shown at block 708, a logic unit within the processor performs an additional operation to fetch the source coordinate values from the source operand values by rotating or shifting the coordinate values into individual temporary registers. In one embodiment, the logic unit includes hardware to automatically isolate the source coordinate values from the source operand without requiring an unpack operation. For example, each source coordinate can be a separate data element in a vector instruction.

As shown at block 710, once the source coordinate values are fetched, the decoded instruction causes one or more execution units to compute the Z-curve index. In one embodiment the Z-curve index is based on at least 8 low-order bits of each source coordinate value and computed by interleaving the constituent bits of the source coordinate values. In one embodiment the resultant Z-curve index is at least 32 bits in length. In one embodiment the resultant Z-curve index is at least 64 bits in length. For a 64-bit instruction, at least 16 low order bits of each source value can be processed to produce a 64-bit Z-curve index. As shown at block 712, the processor can store the result of Z-curve index instruction into a location indicated by the destination operand. For a 32-bit instruction, the Z-curve index is stored to a 32-bit output register. For a 64-bit instruction, the Z-curve index is stored in a 64-bit output register.

Embodiment described herein refer to operations using X, Y, Z, and T coordinates, which are coordinates used to define a position within a four dimensional space. One having ordinary skill in the art will understand that that the coordinates used are exemplary and the X, Y, Z, and T coordinates generally refer to any set of coordinates used to define a location a first, second, third, or fourth dimension in a four dimensional space to which Z-curve ordering is applicable.

Embodiments of the instruction described herein operate on high order or low order bits within a source coordinate value. As described herein, the high and low order bits are defined as the most significant and least significant bits independent of the convention used to interpret the bytes making up a data word when those bytes are stored in computer memory. In other words, the low-order, or least significant bits may be stored in the smallest address or largest address within a data word, according to the byte order convention in use.

Embodiments described herein are implemented in a processing apparatus or data processing system. In the foregoing description, numerous specific details were set forth to order to provide a thorough understanding of the embodiments described herein. However, the embodiments can be practiced without some of these specific details, as would be clear to one having ordinary skill in the art. Some of the architectural features described are extensions to the Intel Architecture (IA). However, the underlying principles are not limited to any particular instruction set.

An instruction set, or instruction set architecture (ISA), is the part of the computer architecture related to programming, including the native data types, instructions, register architecture, addressing modes, memory architecture, interrupt and exception handling, and external input and output (I/O). It should be noted that the term “instruction” generally refers herein to macro-instructions—that is instructions that are provided to the processor for execution—as opposed to micro-instructions or micro-operations (e.g., micro-ops)—that is the result of a processor's decoder decoding macro-instructions. The micro-instructions or micro-ops can be configured to instruct an execution unit on the processor to perform operations to implement the logic associated with the macro-instruction.

The ISA is distinguished from the microarchitecture, which is the set of processor design techniques used to implement the instruction set. Processors with different microarchitectures can share a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. For example, the same register architecture of the ISA may be implemented in different ways in different microarchitectures using well-known techniques, including dedicated physical registers, one or more dynamically allocated physical registers using a register renaming mechanism (e.g., the use of a Register Alias Table (RAT), a Reorder Buffer (ROB) and a retirement register file). Unless otherwise specified, the phrases register architecture, register file, and register are used herein to refer to that which is visible to the software/programmer and the manner in which instructions specify registers. Where a distinction is required, the adjective “logical,” “architectural,” or “software visible” will be used to indicate registers/files in the register architecture, while different adjectives will be used to designate registers in a given microarchitecture (e.g., physical register, reorder buffer, retirement register, register pool).

An instruction set includes one or more instruction formats. A given instruction format defines various fields (number of bits, location of bits) to specify, among other things, the operation to be performed and the operand(s) on which that operation is to be performed. Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. A given instruction is expressed using a given instruction format (and, if defined, in a given one of the instruction templates of that instruction format) and specifies the operation and the operands. An instruction stream is a specific sequence of instructions, where each instruction in the sequence is an occurrence of an instruction in an instruction format (and, if defined, a given one of the instruction templates of that instruction format).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

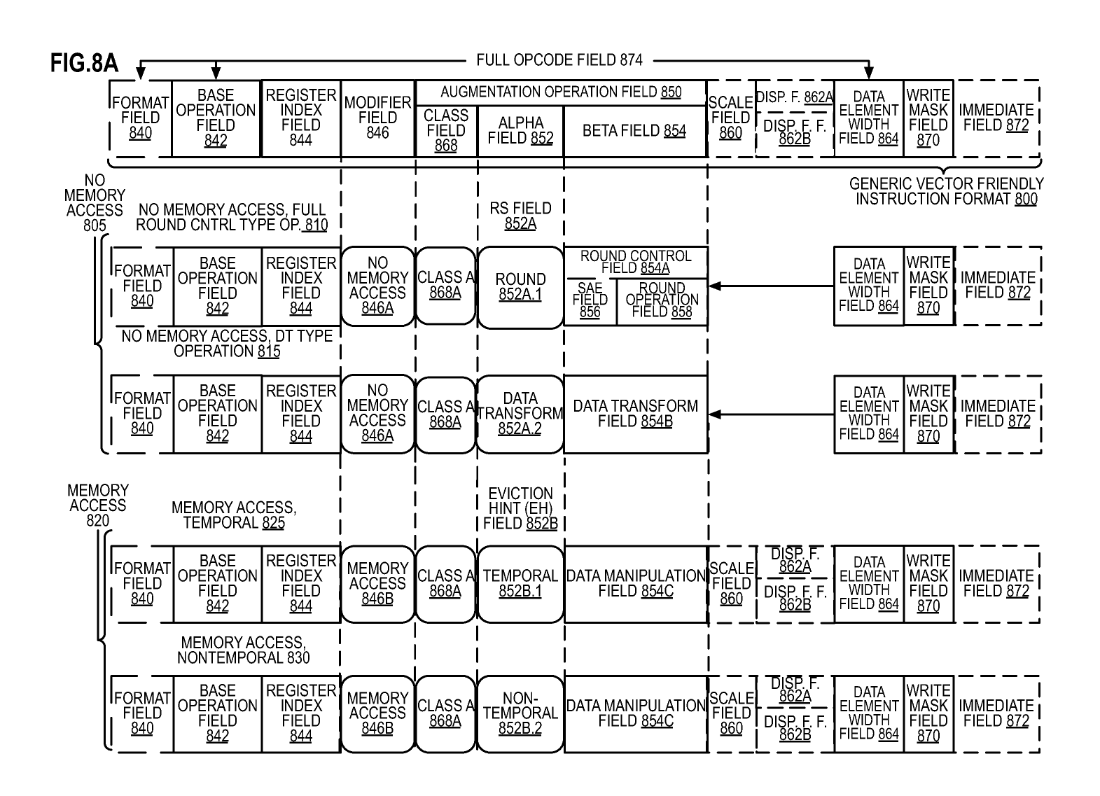

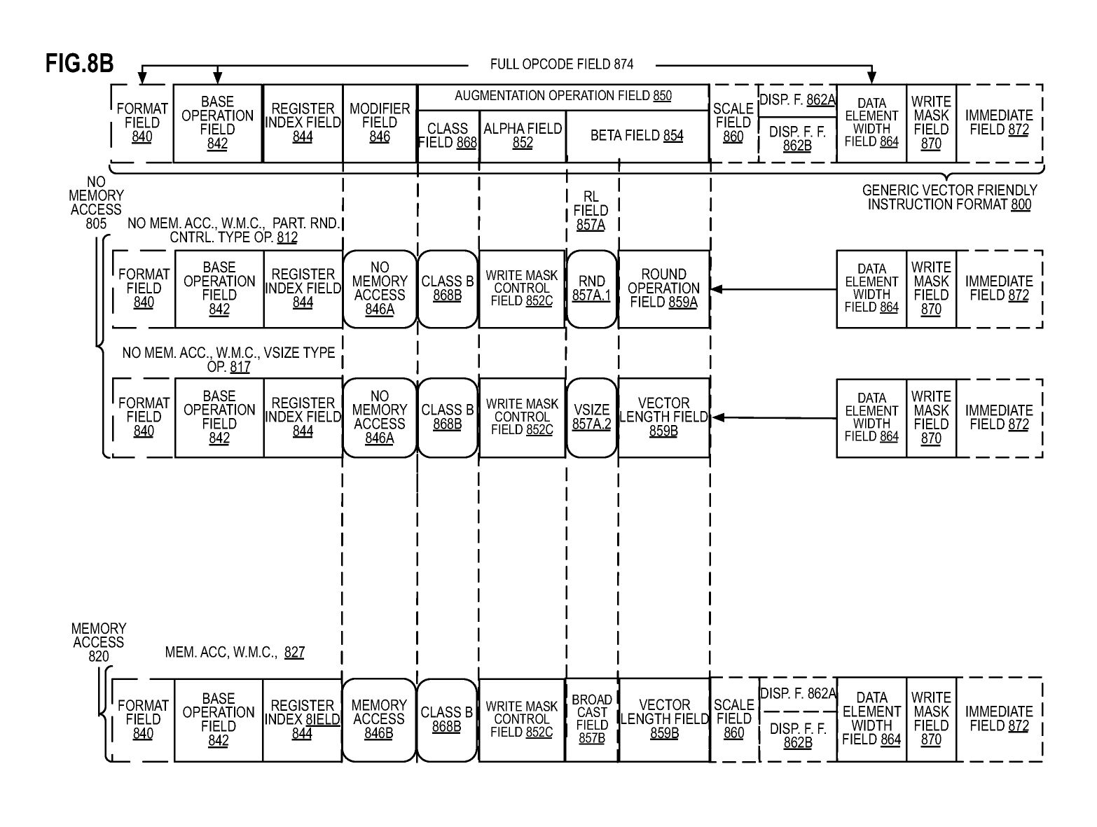

FIGS. 8A-8B are block diagrams illustrating a generic vector friendly instruction format and instruction templates thereof according to an embodiment. FIG. 8A is a block diagram illustrating a generic vector friendly instruction format and class A instruction templates thereof according to an embodiment; while FIG. 8B is a block diagram illustrating the generic vector friendly instruction format and class B instruction templates thereof according to an embodiment. Specifically, a generic vector friendly instruction format 800 for which are defined class A and class B instruction templates, both of which include no memory access 805 instruction templates and memory access 820 instruction templates. The term generic in the context of the vector friendly instruction format refers to the instruction format not being tied to any specific instruction set.

Embodiments will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes). However, alternate embodiments support more, less and/or different vector operand sizes (e.g., 256 byte vector operands) with more, less, or different data element widths (e.g., 128 bit (16 byte) data element widths).

The class A instruction templates in FIG. 8A include: 1) within the no memory access 805 instruction templates there is shown a no memory access, full round control type operation 810 instruction template and a no memory access, data transform type operation 815 instruction template; and 2) within the memory access 820 instruction templates there is shown a memory access, temporal 825 instruction template and a memory access, non-temporal 830 instruction template. The class B instruction templates in FIG. 8B include: 1) within the no memory access 805 instruction templates there is shown a no memory access, write mask control, partial round control type operation 812 instruction template and a no memory access, write mask control, vsize type operation 817 instruction template; and 2) within the memory access 820 instruction templates there is shown a memory access, write mask control 827 instruction template.

The generic vector friendly instruction format 800 includes the following fields listed below in the order illustrated in FIGS. 8A-8B.

Format field 840—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 842—its content distinguishes different base operations.

Register index field 844—its content, directly or through address generation, specifies the locations of the source and destination operands, be they in registers or in memory. These include a sufficient number of bits to select N registers from a P×Q (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 846—its content distinguishes occurrences of instructions in the generic vector instruction format that specify memory access from those that do not; that is, between no memory access 805 instruction templates and memory access 820 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 850—its content distinguishes which one of a variety of different operations to be performed in addition to the base operation. This field is context specific. In one embodiment of the invention, this field is divided into a class field 868, an alpha field 852, and a beta field 854. The augmentation operation field 850 allows common groups of operations to be performed in a single instruction rather than 2, 3, or 4 instructions.

Scale field 860—its content allows for the scaling of the index field's content for memory address generation (e.g., for address generation that uses 2^{scale}*index+base).

Displacement Field 862A—its content is used as part of memory address generation (e.g., for address generation that uses 2^{scale}*index+base+displacement).

Displacement Factor Field 862B (note that the juxtaposition of displacement field 862A directly over displacement factor field 862B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 874 (described later herein) and the data manipulation field 854C. The displacement field 862A and the displacement factor field 862B are optional in the sense that they are not used for the no memory access 805 instruction templates and/or different embodiments may implement only one or none of the two.

Data element width field 864—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 870—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 870 allows for partial vector operations, including loads, stores, arithmetic, logical, etc. While embodiments are described in which the write mask field's 870 content selects one of a number of write mask registers that contains the write mask to be used (and thus the write mask field's 870 content indirectly identifies that masking to be performed), alternative embodiments instead or additional allow the mask write field's 870 content to directly specify the masking to be performed.

Immediate field 872—its content allows for the specification of an immediate. This field is optional in the sense that is it not present in an implementation of the generic vector friendly format that does not support immediate and it is not present in instructions that do not use an immediate.

Class field 868—its content distinguishes between different classes of instructions. With reference to FIGS. 8A-B, the contents of this field select between class A and class B instructions. In FIGS. 8A-B, rounded corner squares are used to indicate a specific value is present in a field (e.g., class A 868A and class B 868B for the class field 868 respectively in FIGS. 8A-B).

### Instruction Templates of Class A

In the case of the non-memory access 805 instruction templates of class A, the alpha field 852 is interpreted as an RS field 852A, whose content distinguishes which one of the different augmentation operation types are to be performed (e.g., round 852A.1 and data transform 852A.2 are respectively specified for the no memory access, round type operation 810 and the no memory access, data transform type operation 815 instruction templates), while the beta field 854 distinguishes which of the operations of the specified type is to be performed. In the no memory access 805 instruction templates, the scale field 860, the displacement field 862A, and the displacement scale filed 862B are not present.

### No-Memory Access Instruction Templates—Full Round Control Type Operation

In the no memory access full round control type operation 810 instruction template, the beta field 854 is interpreted as a round control field 854A, whose content(s) provide static rounding. While in the described embodiments the round control field 854A includes a suppress all floating point exceptions (SAE) field 856 and a round operation control field 858, alternative embodiments may support may encode both these concepts into the same field or only have one or the other of these concepts/fields (e.g., may have only the round operation control field 858).

SAE field 856—its content distinguishes whether or not to disable the exception event reporting; when the SAE field's 856 content indicates suppression is enabled, a given instruction does not report any kind of floating-point exception flag and does not raise any floating point exception handler.

Round operation control field 858—its content distinguishes which one of a group of rounding operations to perform (e.g., Round-up, Round-down, Round-towards-zero and Round-to-nearest). Thus, the round operation control field 858 allows for the changing of the rounding mode on a per instruction basis. In one embodiment of the invention where a processor includes a control register for specifying rounding modes, the round operation control field's 850 content overrides that register value.

### No Memory Access Instruction Templates—Data Transform Type Operation

In the no memory access data transform type operation 815 instruction template, the beta field 854 is interpreted as a data transform field 854B, whose content distinguishes which one of a number of data transforms is to be performed (e.g., no data transform, swizzle, broadcast).

In the case of a memory access 820 instruction template of class A, the alpha field 852 is interpreted as an eviction hint field 852B, whose content distinguishes which one of the eviction hints is to be used (in FIG. 8A, temporal 852B.1 and non-temporal 852B.2 are respectively specified for the memory access, temporal 825 instruction template and the memory access, non-temporal 830 instruction template), while the beta field 854 is interpreted as a data manipulation field 854C, whose content distinguishes which one of a number of data manipulation operations (also known as primitives) is to be performed (e.g., no manipulation; broadcast; up conversion of a source; and down conversion of a destination). The memory access 820 instruction templates include the scale field 860, and optionally the displacement field 862A or the displacement scale field 862B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 852 is interpreted as a write mask control (Z) field 852C, whose content distinguishes whether the write masking controlled by the write mask field 870 should be a merging or a zeroing.

In the case of the non-memory access 805 instruction templates of class B, part of the beta field 854 is interpreted as an RL field 857A, whose content distinguishes which one of the different augmentation operation types are to be performed (e.g., round 857A.1 and vector length (VSIZE) 857A.2 are respectively specified for the no memory access, write mask control, partial round control type operation 812 instruction template and the no memory access, write mask control, VSIZE type operation 817 instruction template), while the rest of the beta field 854 distinguishes which of the operations of the specified type is to be performed. In the no memory access 805 instruction templates, the scale field 860, the displacement field 862A, and the displacement scale filed 862B are not present.

In the no memory access, write mask control, partial round control type operation 810 instruction template, the rest of the beta field 854 is interpreted as a round operation field 859A and exception event reporting is disabled (a given instruction does not report any kind of floating-point exception flag and does not raise any floating point exception handler).

Round operation control field 859A—just as round operation control field 858, its content distinguishes which one of a group of rounding operations to perform (e.g., Round-up, Round-down, Round-towards-zero and Round-to-nearest). Thus, the round operation control field 859A allows for the changing of the rounding mode on a per instruction basis. In one embodiment of the invention where a processor includes a control register for specifying rounding modes, the round operation control field's 850 content overrides that register value.

In the no memory access, write mask control, VSIZE type operation 817 instruction template, the rest of the beta field 854 is interpreted as a vector length field 859B, whose content distinguishes which one of a number of data vector lengths is to be performed on (e.g., 128, 256, or 512 byte).

In the case of a memory access 820 instruction template of class B, part of the beta field 854 is interpreted as a broadcast field 857B, whose content distinguishes whether or not the broadcast type data manipulation operation is to be performed, while the rest of the beta field 854 is interpreted the vector length field 859B. The memory access 820 instruction templates include the scale field 860, and optionally the displacement field 862A or the displacement scale field 862B.

With regard to the generic vector friendly instruction format 800, a full opcode field 874 is shown including the format field 840, the base operation field 842, and the data element width field 864. While one embodiment is shown where the full opcode field 874 includes all of these fields, the full opcode field 874 includes less than all of these fields in embodiments that do not support all of them. The full opcode field 874 provides the operation code (opcode).

The augmentation operation field 850, the data element width field 864, and the write mask field 870 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the invention). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

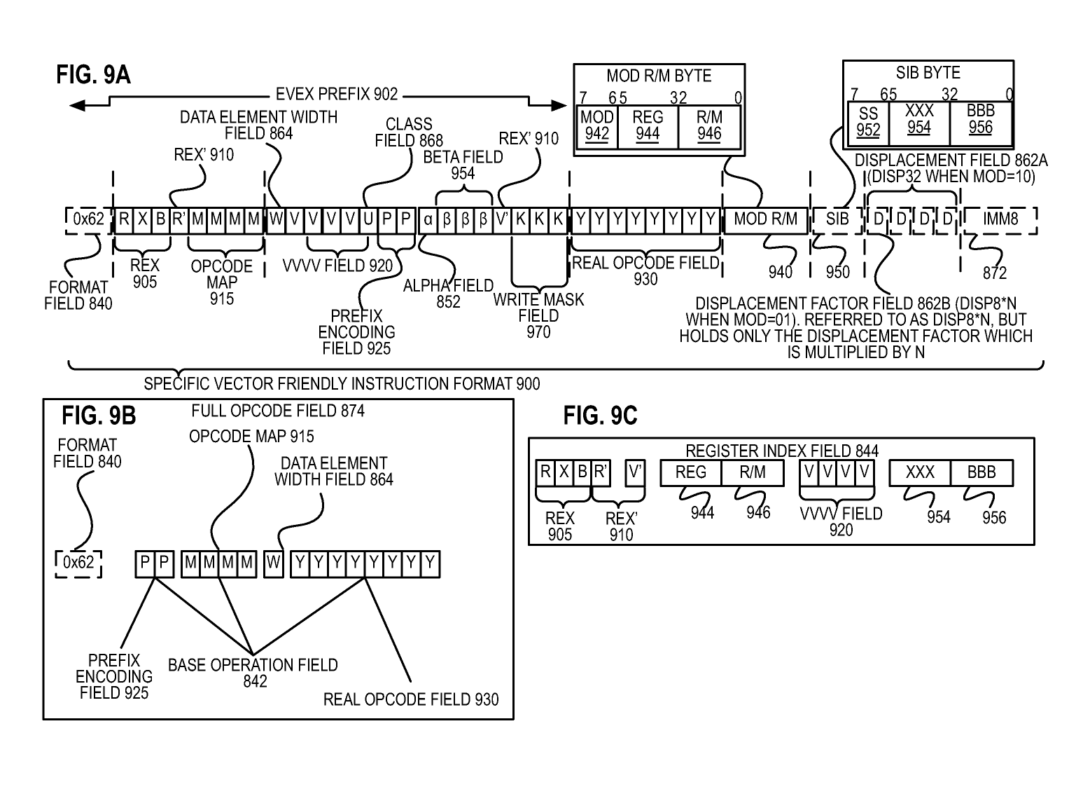

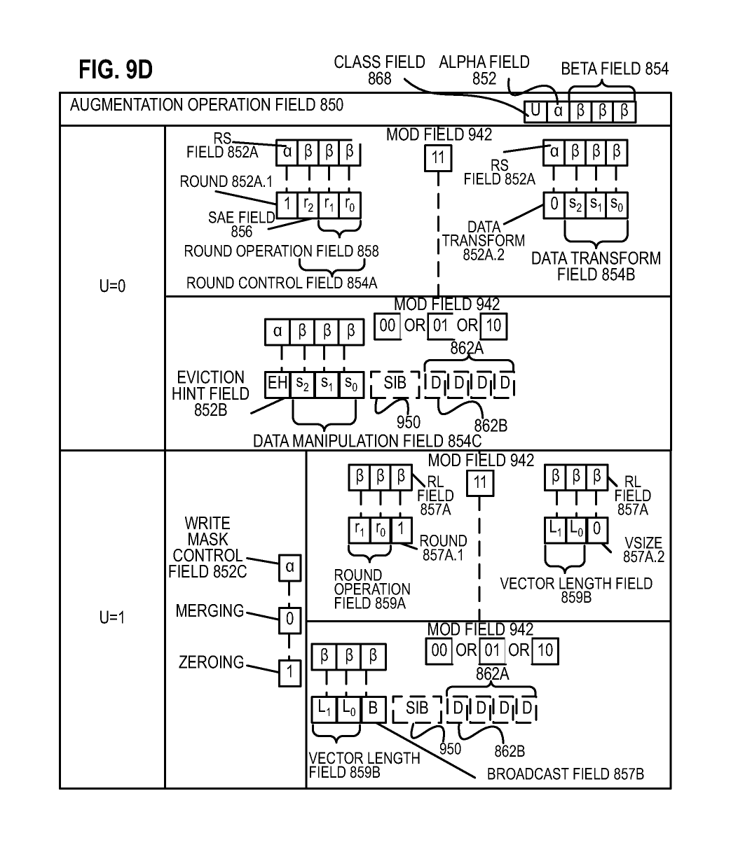

FIG. 9 is a block diagram illustrating an exemplary specific vector friendly instruction format according to an embodiment. FIG. 9 shows a specific vector friendly instruction format 900 that is specific in the sense that it specifies the location, size, interpretation, and order of the fields, as well as values for some of those fields. The specific vector friendly instruction format 900 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 8 into which the fields from FIG. 9 map are illustrated.

It should be understood that, although embodiments are described with reference to the specific vector friendly instruction format 900 in the context of the generic vector friendly instruction format 800 for illustrative purposes, the invention is not limited to the specific vector friendly instruction format 900 except where claimed. For example, the generic vector friendly instruction format 800 contemplates a variety of possible sizes for the various fields, while the specific vector friendly instruction format 900 is shown as having fields of specific sizes. By way of specific example, while the data element width field 864 is illustrated as a one bit field in the specific vector friendly instruction format 900, the invention is not so limited (that is, the generic vector friendly instruction format 800 contemplates other sizes of the data element width field 864).

The generic vector friendly instruction format 800 includes the following fields listed below in the order illustrated in FIG. 9A.

EVEX Prefix (Bytes 0-3) 902—is encoded in a four-byte form.

Format Field 840 (EVEX Byte 0, bits [7:0])—the first byte (EVEX Byte 0) is the format field 840 and it contains 0x62 (the unique value used for distinguishing the vector friendly instruction format in one embodiment of the invention).

The second-fourth bytes (EVEX Bytes 1-3) include a number of bit fields providing specific capability.

REX field 905 (EVEX Byte 1, bits [7-5])—consists of a EVEX.R bit field (EVEX Byte 1, bit [7]-R), EVEX.X bit field (EVEX byte 1, bit [6]-X), and 857BEX byte 1, bit[5]-B). The EVEX.R, EVEX.X, and EVEX.B bit fields provide the same functionality as the corresponding VEX bit fields, and are encoded using 1s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 810—this is the first part of the REX′ field 810 and is the EVEX.R′ bit field (EVEX Byte 1, bit [4]-R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 915 (EVEX byte 1, bits [3:0]-mmmm)—its content encodes an implied leading opcode byte (0F, 0F 38, or 0F 3).

Data element width field 864 (EVEX byte 2, bit [7]-W)—is represented by the notation EVEX.W. EVEX.W is used to define the granularity (size) of the datatype (either 32-bit data elements or 64-bit data elements).

EVEX.vvvv 920 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111 b. Thus, EVEX.vvvv field 920 encodes the 4 low-order bits of the first source register specifier stored in inverted (1s complement) form. Depending on the instruction, an extra different EVEX bit field is used to extend the specifier size to 32 registers.

EVEX.U 868 Class field (EVEX byte 2, bit [2]-U)—If EVEX.U=0, it indicates class A or EVEX.U0; if EVEX.U=1, it indicates class B or EVEX.U1.

Prefix encoding field 925 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 852 (EVEX byte 3, bit [7]-EH; also known as EVEX.EH, EVEX.rs, EVEX.RL, EVEX.write mask control, and EVEX.N; also illustrated with α)—as previously described, this field is context specific.

Beta field 854 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 810—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 870 (EVEX byte 3, bits [2:0]-kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 930 (Byte 4) is also known as the opcode byte. Part of the opcode is specified in this field.

MOD R/M Field 940 (Byte 5) includes MOD field 942, Reg field 944, and R/M field 946. As previously described, the MOD field's 942 content distinguishes between memory access and non-memory access operations. The role of Reg field 944 can be summarized to two situations: encoding either the destination register operand or a source register operand, or be treated as an opcode extension and not used to encode any instruction operand. The role of R/M field 946 may include the following: encoding the instruction operand that references a memory address, or encoding either the destination register operand or a source register operand.

Scale, Index, Base (SIB) Byte (Byte 6)—As previously described, the scale field's 850 content is used for memory address generation. SIB.xxx 954 and SIB.bbb 956—the contents of these fields have been previously referred to with regard to the register indexes Xxxx and Bbbb.

Displacement field 862A (Bytes 7-10)—when MOD field 942 contains 10, bytes 7-10 are the displacement field 862A, and it works the same as the legacy 32-bit displacement (disp32) and works at byte granularity.

Displacement factor field 862B (Byte 7)—when MOD field 942 contains 01, byte 7 is the displacement factor field 862B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 862B is a reinterpretation of disp8; when using displacement factor field 862B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 862B substitutes the legacy x86 instruction set 8-bit displacement. Thus, the displacement factor field 862B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate field 872 operates as previously described.

### Full Opcode Field

FIG. 9B is a block diagram illustrating the fields of the specific vector friendly instruction format 900 that make up the full opcode field 874 according to one embodiment of the invention. Specifically, the full opcode field 874 includes the format field 840, the base operation field 842, and the data element width (W) field 864. The base operation field 842 includes the prefix encoding field 925, the opcode map field 915, and the real opcode field 930.

### Register Index Field

FIG. 9C is a block diagram illustrating the fields of the specific vector friendly instruction format 900 that make up the register index field 844 according to one embodiment of the invention. Specifically, the register index field 844 includes the REX field 905, the REX′ field 910, the MODR/M.reg field 944, the MODR/M.r/m field 946, the VVVV field 920, xxx field 954, and the bbb field 956.

### Augmentation Operation Field

FIG. 9D is a block diagram illustrating the fields of the specific vector friendly instruction format 900 that make up the augmentation operation field 850 according to one embodiment of the invention. When the class (U) field 868 contains 0, it signifies EVEX.U0 (class A 868A); when it contains 1, it signifies EVEX.U1 (class B 868B). When U=0 and the MOD field 942 contains 11 (signifying a no memory access operation), the alpha field 852 (EVEX byte 3, bit [7]-EH) is interpreted as the rs field 852A. When the rs field 852A contains a 1 (round 852A.1), the beta field 854 (EVEX byte 3, bits [6:4]-SSS) is interpreted as the round control field 854A. The round control field 854A includes a one bit SAE field 856 and a two bit round operation field 858. When the rs field 852A contains a 0 (data transform 852A.2), the beta field 854 (EVEX byte 3, bits [6:4]-SSS) is interpreted as a three bit data transform field 854B. When U=0 and the MOD field 942 contains 00, 01, or 10 (signifying a memory access operation), the alpha field 852 (EVEX byte 3, bit [7]-EH) is interpreted as the eviction hint (EH) field 852B and the beta field 854 (EVEX byte 3, bits [6:4]-SSS) is interpreted as a three bit data manipulation field 854C.

When U=1, the alpha field 852 (EVEX byte 3, bit [7]-EH) is interpreted as the write mask control (Z) field 852C. When U=1 and the MOD field 942 contains 11 (signifying a no memory access operation), part of the beta field 854 (EVEX byte 3, bit [4]-S₀) is interpreted as the RL field 857A; when it contains a 1 (round 857A.1) the rest of the beta field 854 (EVEX byte 3, bit [6-5]-S₂₋₁) is interpreted as the round operation field 859A, while when the RL field 857A contains a 0 (VSIZE 857.A2) the rest of the beta field 854 (EVEX byte 3, bit [6-5]-S₂₋₁) is interpreted as the vector length field 859B (EVEX byte 3, bit [6-5]-L₁₋₀). When U=1 and the MOD field 942 contains 00, 01, or 10 (signifying a memory access operation), the beta field 854 (EVEX byte 3, bits [6:4]-SSS) is interpreted as the vector length field 859B (EVEX byte 3, bit [6-5]-L₁₋₀) and the broadcast field 857B (EVEX byte 3, bit [4]-B).

### Exemplary Register Architecture

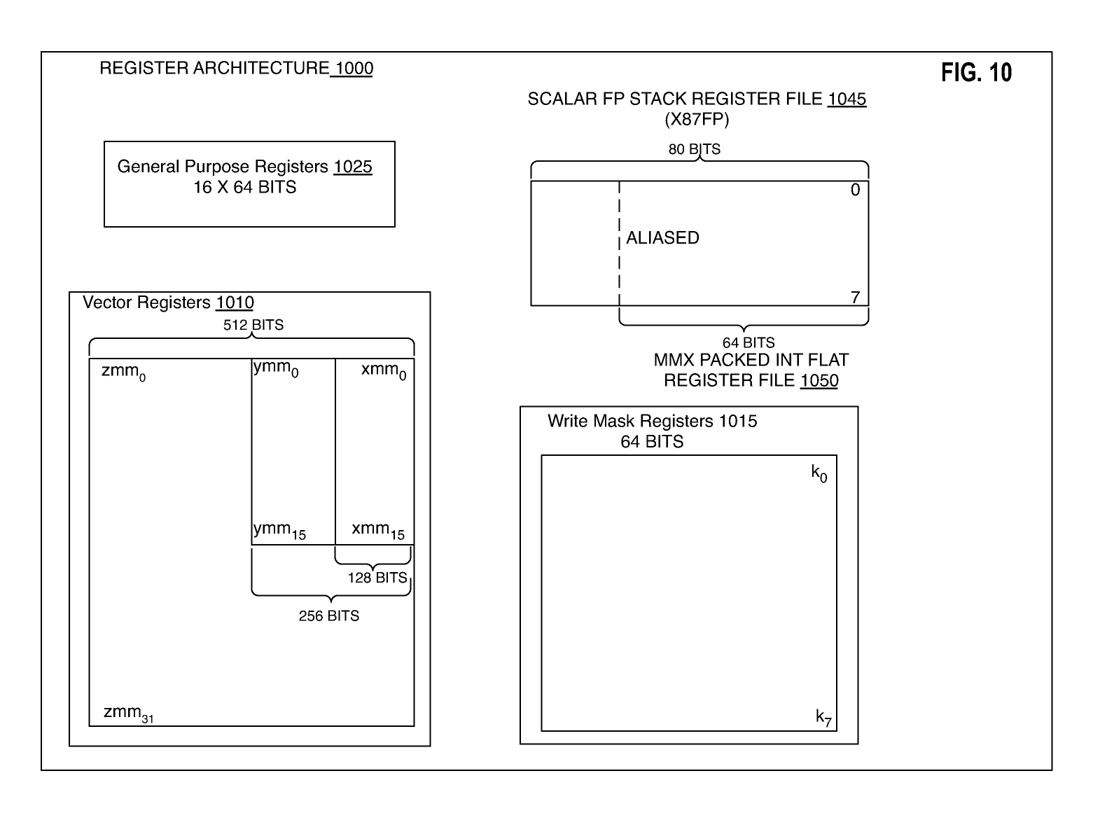

FIG. 10 is a block diagram of a register architecture 1000 according to one embodiment of the invention. In the embodiment illustrated, there are 32 vector registers 1010 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 900 operates on these overlaid register file as illustrated in Table 6 below.

TABLE 6
Registers

| Adjustable | | | |
|---|---|---|---|
| Vector Length | Class | Operations | Registers |
| Instruction | A (FIG. 8A; | 810, 815, 825, | zmm registers |
| Templates that | U = 0) | 830 | (the vector |
| do not include | | | length is 64 byte) |
| the vector length | B (FIG. 8B; | 712 | zmm registers |
| field 859B | U = 1) | | (the vector |
| | | | length is 64 byte) |
| Instruction | B (FIG. 8B; | 817, 8 27 | zmm, ymm, or |
| Templates that | U = 1) | | xmm registers |
| do include the | | | (the vector |
| vector length | | | length is 64 byte, |
| field 8 59B | | | 32 byte, or 16 |
| | | | byte) depending |
| | | | on the vector |
| | | | length field 859B |

In other words, the vector length field 859B selects between a maximum length and one or more other shorter lengths, where each such shorter length is half the length of the preceding length; and instructions templates without the vector length field 859B operate on the maximum vector length. Further, in one embodiment, the class B instruction templates of the specific vector friendly instruction format 900 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1015—in the embodiment illustrated, there are 8 write mask registers (k0 through k7), each 64 bits in size. In an alternate embodiment, the write mask registers 1015 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 1025—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1045, on which is aliased the MMX packed integer flat register file 1050—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments may use wider or narrower registers. Additionally, alternative embodiments may use more, less, or different register files and registers.

To provide a more complete understanding, an overview of exemplary processor core architectures, processors, and computer architectures is provided below.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

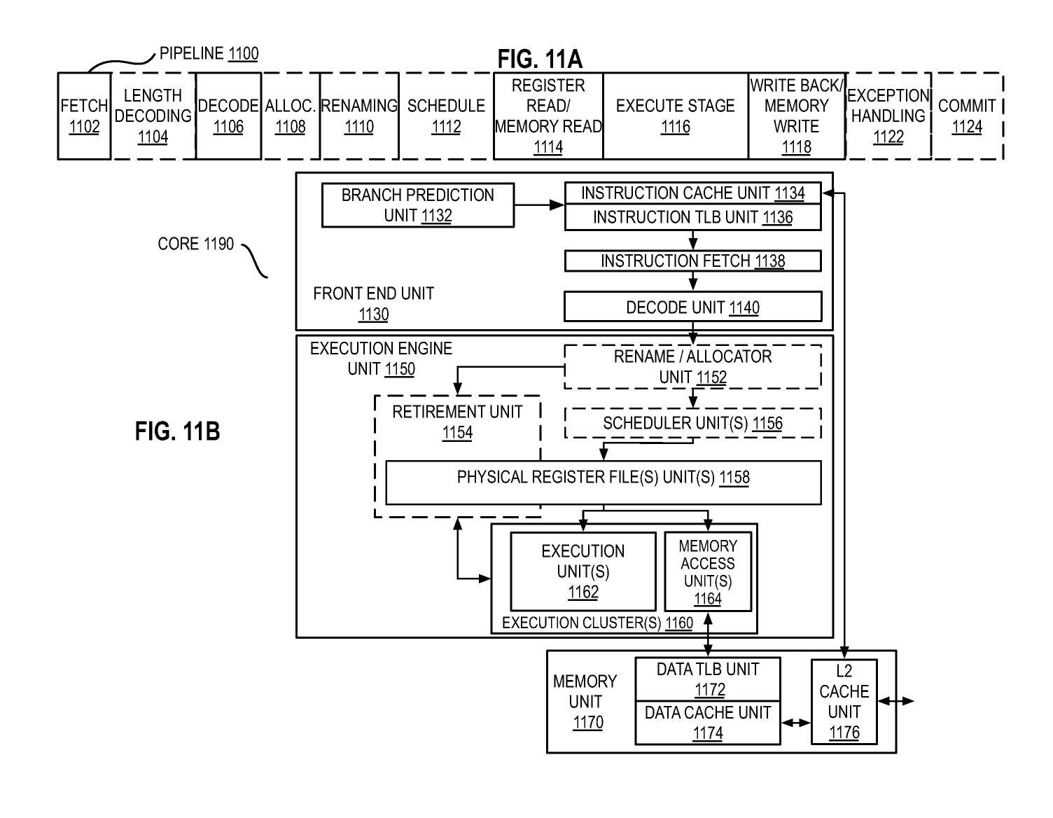

FIG. 11A is a block diagram illustrating both an exemplary in-order pipeline and an exemplary register renaming, out-of-order issue/execution pipeline according to an embodiment. FIG. 11B is a block diagram illustrating both an exemplary embodiment of an in-order architecture core and an exemplary register renaming, out-of-order issue/execution architecture core to be included in a processor according to an embodiment. The solid lined boxes in FIGS. 11A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11A, a processor pipeline 1100 includes a fetch stage 1102, a length decode stage 1104, a decode stage 1106, an allocation stage 1108, a renaming stage 1110, a scheduling (also known as a dispatch or issue) stage 1112, a register read/memory read stage 1114, an execute stage 1116, a write back/memory write stage 1118, an exception handling stage 1122, and a commit stage 1124.

FIG. 11B shows processor core 1190 including a front end unit 1130 coupled to an execution engine unit 1150, and both are coupled to a memory unit 1170. The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front end unit 1130 includes a branch prediction unit 1132 coupled to an instruction cache unit 1134, which is coupled to an instruction translation lookaside buffer (TLB) 1136, which is coupled to an instruction fetch unit 1138, which is coupled to a decode unit 1140. The decode unit 1140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1190 includes a microcode ROM or other medium that stores microcode for certain macroinstructions (e.g., in decode unit 1140 or otherwise within the front end unit 1130). The decode unit 1140 is coupled to a rename/allocator unit 1152 in the execution engine unit 1150.

The execution engine unit 1150 includes the rename/allocator unit 1152 coupled to a retirement unit 1154 and a set of one or more scheduler unit(s) 1156. The scheduler unit(s) 1156 represents any number of different schedulers, including reservations stations, central instruction window, etc. The scheduler unit(s) 1156 is coupled to the physical register file(s) unit(s) 1158. Each of the physical register file(s) units 1158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1158 comprises a vector registers unit, a write mask registers unit, and a scalar registers unit. These register units may provide architectural vector registers, vector mask registers, and general purpose registers. The physical register file(s) unit(s) 1158 is overlapped by the retirement unit 1154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1154 and the physical register file(s) unit(s) 1158 are coupled to the execution cluster(s) 1160. The execution cluster(s) 1160 includes a set of one or more execution units 1162 and a set of one or more memory access units 1164. The execution units 1162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1156, physical register file(s) unit(s) 1158, and execution cluster(s) 1160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1164). It should also be understood that where separate pipelines are used, one or more of these pipelines may be out-of-order issue/execution and the rest in-order.

The set of memory access units 1164 is coupled to the memory unit 1170, which includes a data TLB unit 1172 coupled to a data cache unit 1174 coupled to a level 2 (L2) cache unit 1176. In one exemplary embodiment, the memory access units 1164 may include a load unit, a store address unit, and a store data unit, each of which is coupled to the data TLB unit 1172 in the memory unit 1170. The instruction cache unit 1134 is further coupled to a level 2 (L2) cache unit 1176 in the memory unit 1170. The L2 cache unit 1176 is coupled to one or more other levels of cache and eventually to a main memory.

By way of example, the exemplary register renaming, out-of-order issue/execution core architecture may implement the pipeline 1100 as follows: 1) the instruction fetch 1138 performs the fetch and length decoding stages 1102 and 1104; 2) the decode unit 1140 performs the decode stage 1106; 3) the rename/allocator unit 1152 performs the allocation stage 1108 and renaming stage 1110; 4) the scheduler unit(s) 1156 performs the schedule stage 1112; 5) the physical register file(s) unit(s) 1158 and the memory unit 1170 perform the register read/memory read stage 1114; the execution cluster 1160 perform the execute stage 1116; 6) the memory unit 1170 and the physical register file(s) unit(s) 1158 perform the write back/memory write stage 1118; 7) various units may be involved in the exception handling stage 1122; and 8) the retirement unit 1154 and the physical register file(s) unit(s) 1158 perform the commit stage 1124.

The core 1190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of San Jose, Calif.), including the instruction(s) described herein. In one embodiment, the core 1190 includes logic to support a packed data instruction set extension (e.g., AVX1, AVX2, and/or some form of the generic vector friendly instruction format (U=0 and/or U=1) previously described), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1134/1174 and a shared L2 cache unit 1176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary in-Order Core Architecture

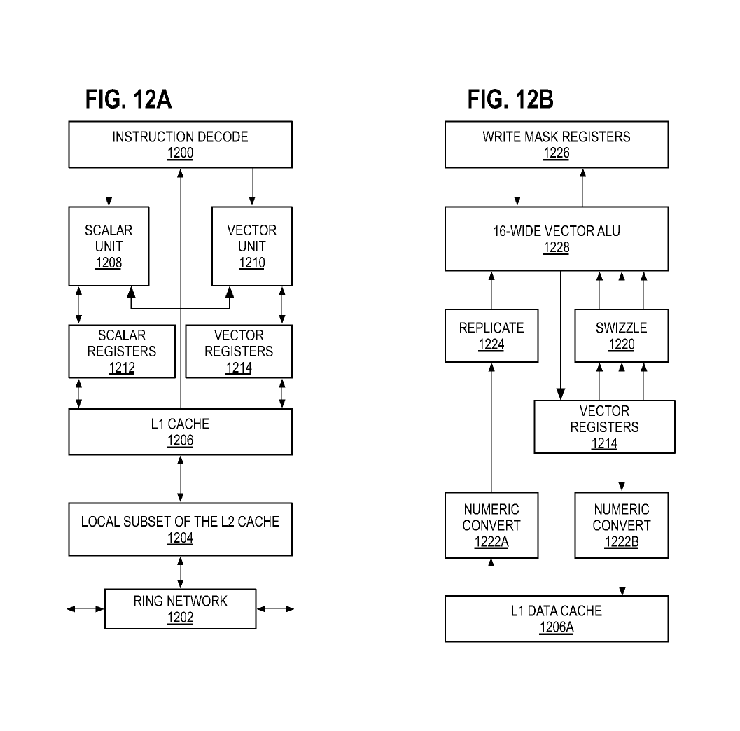

FIGS. 12A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 12A is a block diagram of a single processor core, along with its connection to the on-die interconnect network 1202 and with its local subset of the Level 2 (L2) cache 1204, according to an embodiment. In one embodiment, an instruction decoder 1200 supports the x86 instruction set with a packed data instruction set extension. An L1 cache 1206 allows low-latency accesses to cache memory into the scalar and vector units. While in one embodiment (to simplify the design), a scalar unit 1208 and a vector unit 1210 use separate register sets (respectively, scalar registers 1212 and vector registers 1214) and data transferred between them is written to memory and then read back in from a level 1 (L1) cache 1206, alternative embodiments may use a different approach (e.g., use a single register set or include a communication path that allow data to be transferred between the two register files without being written and read back).

The local subset of the L2 cache 1204 is part of a global L2 cache that is divided into separate local subsets, one per processor core. Each processor core has a direct access path to its own local subset of the L2 cache 1204. Data read by a processor core is stored in its L2 cache subset 1204 and can be accessed quickly, in parallel with other processor cores accessing their own local L2 cache subsets. Data written by a processor core is stored in its own L2 cache subset 1204 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 12B is an expanded view of part of the processor core in FIG. 12A according to an embodiment. FIG. 12B includes an L1 data cache 1206A part of the L1 cache 1204, as well as more detail regarding the vector unit 1210 and the vector registers 1214. Specifically, the vector unit 1210 is a 16-wide vector processing unit (VPU) (see the 16-wide ALU 1228), which executes one or more of integer, single-precision float, and double-precision float instructions. The VPU supports swizzling the register inputs with swizzle unit 1220, numeric conversion with numeric convert units 1222A-B, and replication with replication unit 1224 on the memory input. Write mask registers 1226 allow predicating resulting vector writes.

### Processor with Integrated Memory Controller and Graphics

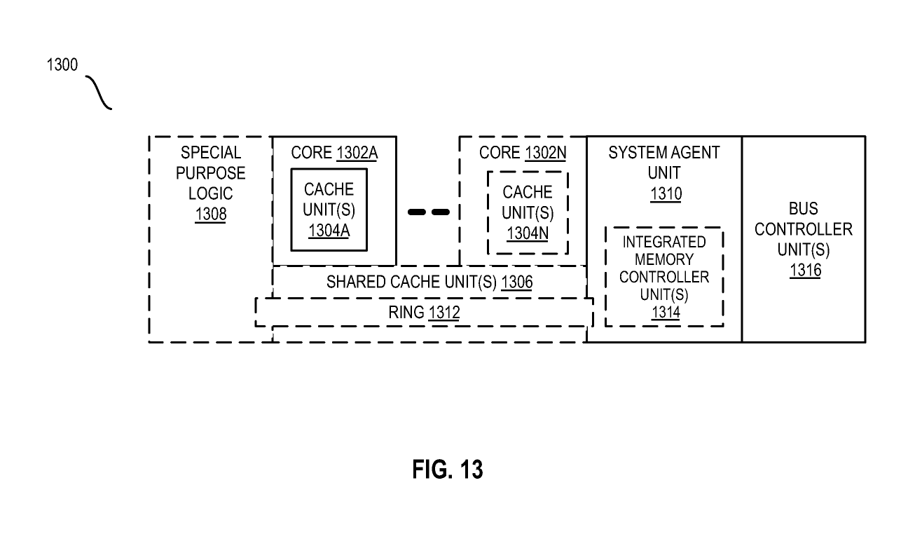

FIG. 13 is a block diagram of a processor 1300 that may have more than one core, may have an integrated memory controller, and may have integrated graphics according to an embodiment. The solid lined boxes in FIG. 13 illustrate a processor 1300 with a single core 1302A, a system agent 1310, a set of one or more bus controller units 1316, while the optional addition of the dashed lined boxes illustrates an alternative processor 1300 with multiple cores 1302A-N, a set of one or more integrated memory controller unit(s) 1314 in the system agent unit 1310, and special purpose logic 1308.

Thus, different implementations of the processor 1300 may include: 1) a CPU with the special purpose logic 1308 being integrated graphics and/or scientific (throughput) logic (which may include one or more cores), and the cores 1302A-N being one or more general purpose cores (e.g., general purpose in-order cores, general purpose out-of-order cores, a combination of the two); 2) a coprocessor with the cores 1302A-N being a large number of special purpose cores intended primarily for graphics and/or scientific (throughput); and 3) a coprocessor with the cores 1302A-N being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1306, and external memory (not shown) coupled to the set of integrated memory controller units 1314. The set of shared cache units 1306 may include one or more mid-level caches, such as level 2 (L2), level 3 (L3), level 4 (L4), or other levels of cache, a last level cache (LLC), and/or combinations thereof. While in one embodiment a ring based interconnect unit 1312 interconnects the integrated graphics logic 1308, the set of shared cache units 1306, and the system agent unit 1310/integrated memory controller unit(s) 1314, alternative embodiments may use any number of well-known techniques for interconnecting such units. In one embodiment, coherency is maintained between one or more cache units 1306 and cores 1302-A-N.

In some embodiments, one or more of the cores 1302A-N are capable of multi-threading. The system agent 1310 includes those components coordinating and operating cores 1302A-N. The system agent unit 1310 may include for example a power control unit (PCU) and a display unit. The PCU may be or include logic and components needed for regulating the power state of the cores 1302A-N and the integrated graphics logic 1308. The display unit is for driving one or more externally connected displays.

The cores 1302A-N may be homogenous or heterogeneous in terms of architecture instruction set; that is, two or more of the cores 1302A-N may be capable of execution the same instruction set, while others may be capable of executing only a subset of that instruction set or a different instruction set.

### Exemplary Computer Architectures

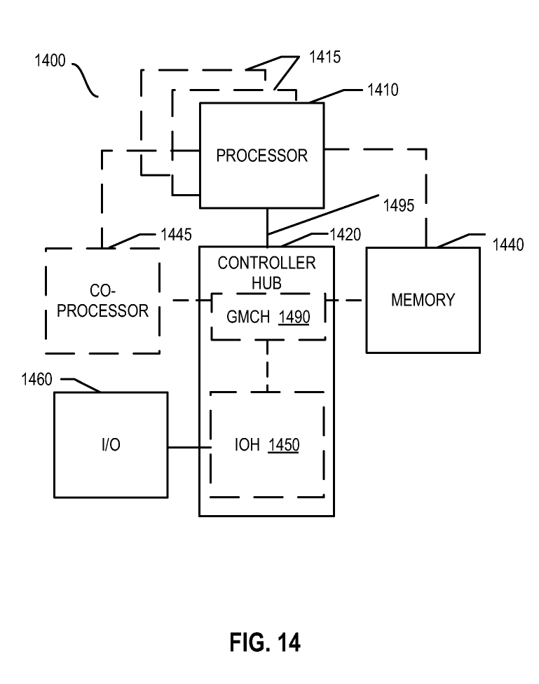

FIGS. 14-17 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 14, shown is a block diagram of a system 1400 in accordance with one embodiment of the present invention. The system 1400 may include one or more processors 1410, 1415, which are coupled to a controller hub 1420. In one embodiment the controller hub 1420 includes a graphics memory controller hub (GMCH) 1490 and an Input/Output Hub (IOH) 1450 (which may be on separate chips); the GMCH 1490 includes memory and graphics controllers to which are coupled memory 1440 and a coprocessor 1445; the IOH 1450 is couples input/output (I/O) devices 1460 to the GMCH 1490. Alternatively, one or both of the memory and graphics controllers are integrated within the processor (as described herein), the memory 1440 and the coprocessor 1445 are coupled directly to the processor 1410, and the controller hub 1420 in a single chip with the IOH 1450.

The optional nature of additional processors 1415 is denoted in FIG. 14 with broken lines. Each processor 1410, 1415 may include one or more of the processing cores described herein and may be some version of the processor 1300.

The memory 1440 may be, for example, dynamic random access memory (DRAM), phase change memory (PCM), or a combination of the two. For at least one embodiment, the controller hub 1420 communicates with the processor(s) 1410, 1415 via a multi-drop bus, such as a frontside bus (FSB), point-to-point interface such as QuickPath Interconnect (QPI), or similar connection 1495.

In one embodiment, the coprocessor 1445 is a special-purpose processor, such as, for example, a high-throughput MIC processor, a network or communication processor, compression engine, graphics processor, GPGPU, embedded processor, or the like. In one embodiment, controller hub 1420 may include an integrated graphics accelerator.

There can be a variety of differences between the physical resources 1410, 1415 in terms of a spectrum of metrics of merit including architectural, microarchitectural, thermal, power consumption characteristics, and the like.

In one embodiment, the processor 1410 executes instructions that control data processing operations of a general type. Embedded within the instructions may be coprocessor instructions. The processor 1410 recognizes these coprocessor instructions as being of a type that should be executed by the attached coprocessor 1445. Accordingly, the processor 1410 issues these coprocessor instructions (or control signals representing coprocessor instructions) on a coprocessor bus or other interconnect, to coprocessor 1445. Coprocessor(s) 1445 accept and execute the received coprocessor instructions.

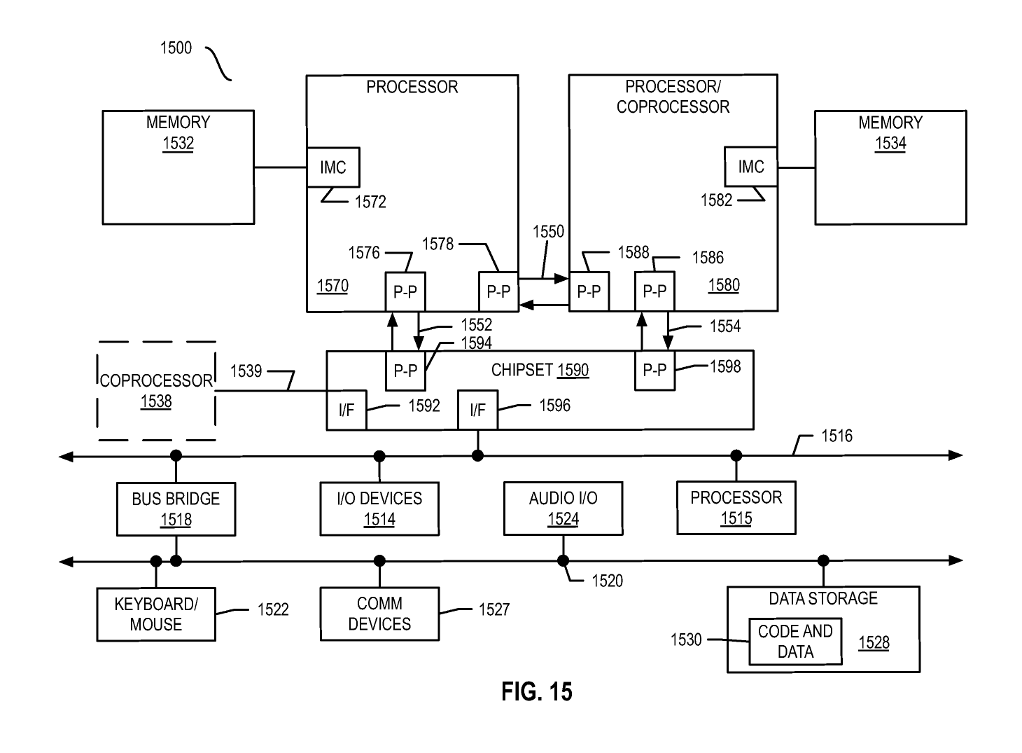

Referring now to FIG. 15, shown is a block diagram of a first more specific exemplary system 1500 in accordance with an embodiment of the present invention. As shown in FIG. 15, multiprocessor system 1500 is a point-to-point interconnect system, and includes a first processor 1570 and a second processor 1580 coupled via a point-to-point interconnect 1550. Each of processors 1570 and 1580 may be some version of the processor 1300. In one embodiment of the invention, processors 1570 and 1580 are respectively processors 1410 and 1415, while coprocessor 1538 is coprocessor 1445. In another embodiment, processors 1570 and 1580 are respectively processor 1410 coprocessor 1445.

Processors 1570 and 1580 are shown including integrated memory controller (IMC) units 1572 and 1582, respectively. Processor 1570 also includes as part of its bus controller units point-to-point (P-P) interfaces 1576 and 1578; similarly, second processor 1580 includes P-P interfaces 1586 and 1588. Processors 1570, 1580 may exchange information via a point-to-point (P-P) interface 1550 using P-P interface circuits 1578, 1588. As shown in FIG. 15, IMCs 1572 and 1582 couple the processors to respective memories, namely a memory 1532 and a memory 1534, which may be portions of main memory locally attached to the respective processors.

Processors 1570, 1580 may each exchange information with a chipset 1590 via individual P-P interfaces 1552, 1554 using point to point interface circuits 1576, 1594, 1586, 1598. Chipset 1590 may optionally exchange information with the coprocessor 1538 via a high-performance interface 1539. In one embodiment, the coprocessor 1538 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1590 may be coupled to a first bus 1516 via an interface 1596. In one embodiment, first bus 1516 may be a Peripheral Component Interconnect (PCI) bus, or a bus such as a PCI Express bus or another third generation I/O interconnect bus, although the scope of the present invention is not so limited.

As shown in FIG. 15, various I/O devices 1514 may be coupled to first bus 1516, along with a bus bridge 1518 which couples first bus 1516 to a second bus 1520. In one embodiment, one or more additional processor(s) 1515, such as coprocessors, high-throughput MIC processors, GPGPU's, accelerators (such as, e.g., graphics accelerators or digital signal processing (DSP) units), field programmable gate arrays, or any other processor, are coupled to first bus 1516. In one embodiment, second bus 1520 may be a low pin count (LPC) bus. Various devices may be coupled to a second bus 1520 including, for example, a keyboard and/or mouse 1522, communication devices 1527 and a storage unit 1528 such as a disk drive or other mass storage device which may include instructions/code and data 1530, in one embodiment. Further, an audio I/O 1524 may be coupled to the second bus 1520. Note that other architectures are possible. For example, instead of the point-to-point architecture of FIG. 15, a system may implement a multi-drop bus or other such architecture.

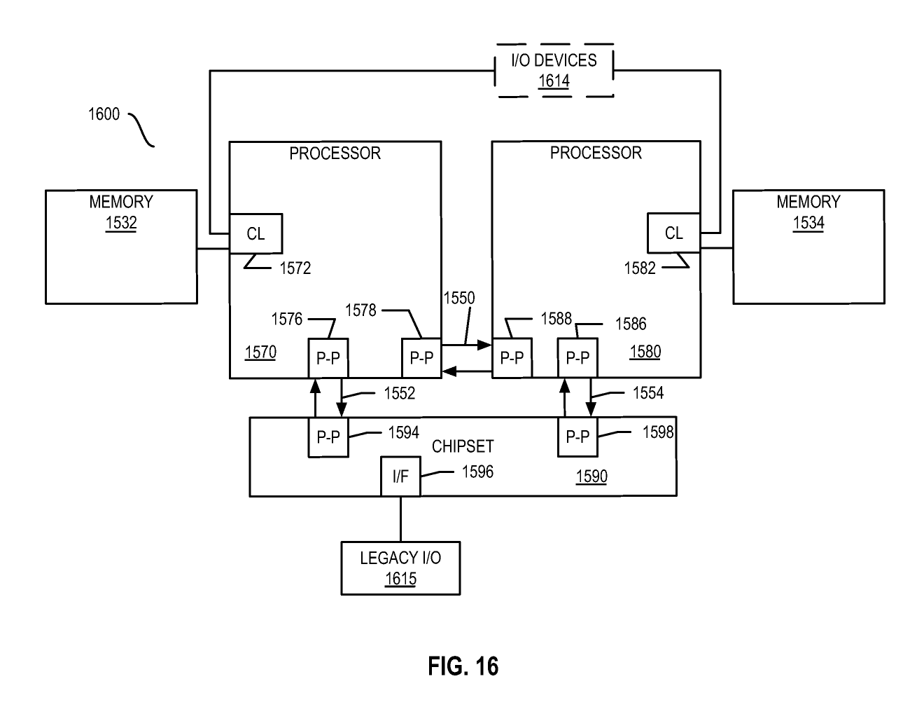

Referring now to FIG. 16, shown is a block diagram of a second more specific exemplary system 1600 in accordance with an embodiment of the present invention. Like elements in FIGS. 15 and 16 bear like reference numerals, and certain aspects of FIG. 15 have been omitted from FIG. 16 in order to avoid obscuring other aspects of FIG. 16.

FIG. 16 illustrates that the processors 1570, 1580 may include integrated memory and I/O control logic (“CL”) 1572 and 1582, respectively. Thus, the CL 1572, 1582 include integrated memory controller units and include I/O control logic. FIG. 16 illustrates that not only are the memories 1532, 1534 coupled to the CL 1572, 1582, but also that I/O devices 1614 are also coupled to the control logic 1572, 1582. Legacy I/O devices 1615 are coupled to the chipset 1590.

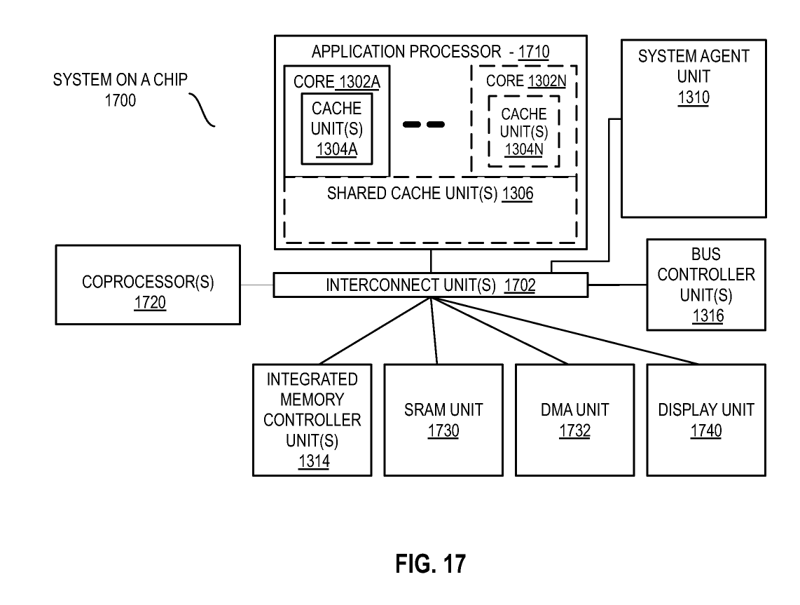

Referring now to FIG. 17, shown is a block diagram of a SoC 1700 in accordance with an embodiment of the present invention. Similar elements in FIG. 13 bear like reference numerals. Also, dashed lined boxes are optional features on more advanced SoCs. In FIG. 17, an interconnect unit(s) 1702 is coupled to: an application processor 1710 which includes a set of one or more cores 202A-N and shared cache unit(s) 1306; a system agent unit 1310; a bus controller unit(s) 1316; an integrated memory controller unit(s) 1314; a set or one or more coprocessors 1720 which may include integrated graphics logic, an image processor, an audio processor, and a video processor; an static random access memory (SRAM) unit 1730; a direct memory access (DMA) unit 1732; and a display unit 1740 for coupling to one or more external displays. In one embodiment, the coprocessor(s) 1720 include a special-purpose processor, such as, for example, a network or communication processor, compression engine, GPGPU, a high-throughput MIC processor, embedded processor, or the like.

Embodiments of the mechanisms disclosed herein are implemented in hardware, software, firmware, or a combination of such implementation approaches. Embodiments are implemented as computer programs or program code executing on programmable systems comprising at least one processor, a storage system (including volatile and non-volatile memory and/or storage elements), at least one input device, and at least one output device.

Program code, such as code 1530 illustrated in FIG. 15, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, an embodiment also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

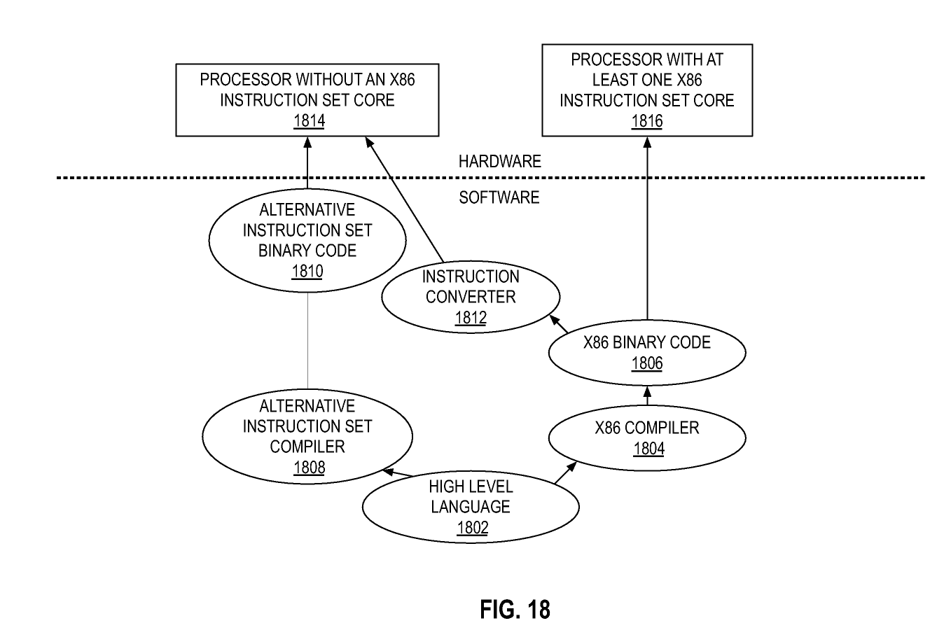

FIG. 18 is a block diagram contrasting the use of a software instruction converter to convert binary instructions in a source instruction set to binary instructions in a target instruction set according to an embodiment. In the illustrated embodiment, the instruction converter is a software instruction converter, although alternatively the instruction converter may be implemented in software, firmware, hardware, or various combinations thereof. FIG. 18 shows a program in a high level language 1802 may be compiled using an x86 compiler 1804 to generate x86 binary code 1806 that may be natively executed by a processor with at least one x86 instruction set core 1816.

The processor with at least one x86 instruction set core 1816 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1804 represents a compiler that is operable to generate x86 binary code 1806 (e.g., object code) that can, with or without additional linkage processing, be executed on the processor with at least one x86 instruction set core 1816. Similarly, FIG. 18 shows the program in the high level language 1802 may be compiled using an alternative instruction set compiler 1808 to generate alternative instruction set binary code 1810 that may be natively executed by a processor without at least one x86 instruction set core 1814 (e.g., a processor with cores that execute the MIPS instruction set of MIPS Technologies of Sunnyvale, Calif. and/or that execute the ARM instruction set of ARM Holdings of San Jose, Calif.).

The instruction converter 1812 is used to convert the x86 binary code 1806 into code that may be natively executed by the processor without an x86 instruction set core 1814. This converted code is not likely to be the same as the alternative instruction set binary code 1810 because an instruction converter capable of this is difficult to make; however, the converted code will accomplish the general operation and be made up of instructions from the alternative instruction set. Thus, the instruction converter 1812 represents software, firmware, hardware, or a combination thereof that, through emulation, simulation or any other process, allows a processor or other electronic device that does not have an x86 instruction set processor or core to execute the x86 binary code 1806.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

The instructions described herein refer to specific configurations of hardware, such as application specific integrated circuits (ASICs), configured to perform certain operations or having a predetermined functionality. Such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device.

Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well-known structures and functions were not described in elaborate detail in order to avoid obscuring the subject matter of the present invention. Accordingly, the scope and spirit of the invention should be judged in terms of the claims that follow.

What is claimed is:

1. A processor comprising:
a decode unit to decode an instruction having multiple source operands to produce a decoded instruction, each operand associated with two of a first, second, third, and fourth coordinate; and
an execution unit to execute the decoded instruction and interleave bits of the source operands to compute a four-dimensional z-curve index.

2. The processor as in claim 1 further comprising an instruction fetch unit to fetch the instruction, wherein the instruction is a single machine-level instruction.

3. The processor as in claim 1 further comprising a register file unit to commit the z-curve index to a register associated with a destination operand.

4. The processor as in claim 3 wherein the register file unit further to store a set of registers comprising:
a first register to store a first source operand;
a second register to store a second source operand; and
wherein the first source operand and the second source operand to store multiple coordinate values.

5. The processor as in claim 4 wherein:
the first source operand to include an first dimension coordinate and a second dimension coordinate; and
the second source operand to include a third dimension coordinate and a fourth dimension coordinate.

6. The processor as in claim 1 wherein the execution unit to input 8 low-order bits of a value of each source dimension coordinate and output a 32-bit result.

7. The processor as in claim 1 wherein the execution unit to input 16 low-order bits of a value of each source dimension coordinate and output a 64-bit result.

8. A logic unit comprising:
multiple registers to store multiple source values for a set of operations to compute a four-dimensional z-curve index; and
an execution unit to input low-order bits of each of the multiple registers and interleave the bits to compute the four-dimensional z-curve index.

9. The logic unit as in claim 8 wherein the multiple registers include:
a first register to store a first source value; and
a second register to store a second source value.

10. The logic unit as in claim 9, wherein:
the first source value to indicate a first dimension coordinate and a second dimension coordinate; and
the second source value to indicate a third dimension coordinate and a fourth dimension coordinate.

11. The logic unit as in claim 10 further comprising a fourth register to store a result.

12. The logic unit as in claim 11 wherein the execution unit to input 8 low-order bits of each of dimension coordinate and output a 32-bit result to the fourth register.

13. The logic unit as in claim 11 wherein the execution unit to input 16 low-order bits of each of dimension coordinate and output a 64-bit result.

14. The logic unit as in claim 11 wherein the execution unit to compute the z-curve index via one or more AND, XOR, and shift operations in response to a single instruction.

15. The logic unit as in claim 14 wherein the shift operation includes a left shift and the logic unit further to:
fetch the first or second dimension coordinate via a right shift operation on the first source value; and
fetch the third or fourth dimension coordinate via a right shift operation of the second source value.

16. An apparatus comprising:
an instruction fetch unit to fetch a single instruction to compute a four-dimensional z-curve index, the instruction having two source operands and a destination operand, wherein each source operand is associated with two of a first, second, third, and fourth coordinate;
a decode unit to decode the single instruction into a decoded instruction;
a register file unit including multiple registers to store source coordinate values for the decoded instruction, the source coordinate values unpacked from source operand values; and
an execution unit to retrieve bits of each of the multiple registers and interleave the bits to compute the four-dimensional z-curve index.

17. The apparatus as in claim 16 wherein execution unit includes an XOR logic gate, an AND logic gate, and a shifter circuit.

18. The apparatus as in claim 16 wherein the register file unit further to commit the z-curve index to a register associated with the destination operand.

19. The apparatus as in claim 18 wherein the register file unit further to commit the z-curve index to a 32-bit register indicated by the destination operand and the execution unit further to compute the z-curve index based on at least 8 low-order bits.

20. The apparatus as in claim 18 wherein the register file unit further to commit the z-curve index to a 64-bit register indicated by the destination operand and the execution unit further to compute the z-curve index based on at least 16 low-order bits.

21. A machine-readable medium having stored thereon data, which if performed by at least one machine, causes the at least one machine to fabricate at least one integrated circuit to perform a method comprising:
fetching a single instruction to compute a four-dimensional z-curve index, the instruction having two source operands and a destination operand;
decoding the single instruction into a decoded instruction;
fetching source operand values associated with the two source operands, the source operand values including source coordinate values for a first, second, third and fourth dimension;
unpacking source coordinate values from the source operand values; and
executing the decoded instruction to compute the z-curve index based on bits of source coordinate values by interleaving the bits into four-dimensional z-curve index.

22. The medium as in claim 21 wherein executing the decoded instruction further comprises computing the z-curve index using one or more AND, XOR, and shift operations.

23. The medium as in claim 22 wherein the executing uses an XOR logic gate, an AND logic gate, and a shifter circuit.

24. The medium as in claim 21 further comprising committing the z-curve index to a 32-bit register indicated by the destination operand and computing the z-curve index based on at least 8 low-order bits of each source coordinate value.

25. The medium as in claim 21 further comprising committing the z-curve index to a 64-bit register indicated by the destination operand and computing the z-curve index based on at least 16 low-order bits of each source coordinate value.
